(19) United States
(12) Patent Application Publication
(10) Pub. No.: US 2019/0055392 A1
(43) Pub. Date: Feb. 21, 2019

(54) PARTICLE-BASED MULTI-NETWORK POLYMERS

(71) Applicant: DSM IP Assets, B.V., TE HEERLEN (NL)

(72) Inventors: Markus Johannes Henricus BULTERS, Echt (NL); Meredith Elsa WISEMAN, 6100 AA ECHT (NL); Guido Joseph Elisabeth HENSEN, 6100 AA ECHT (NL); Paulus Antonius Maria STEEMAN, 6100 AA ECHT (NL); Constantino CRETON, 6100 AA ECHT (NL); Etienne DUCROT, 6100 AA ECHT (NL)

(73) Assignee: DSM IP Assets, B.V., TE HEERLEN (NL)

(21) Appl. No.: 15/763,188

(22) PCT Filed: Oct. 3, 2016
(86) PCT No.: PCT/EP2016/073577

§ 371 Date: Mar. 26, 2018

(30) Foreign Application Priority Data
Oct. 2, 2015 (EP) EP15188144.8

(51) Int. Cl. C08L 33/08; C08J 9/228; C08J 9/00; C09D 7/65; C09D 4/06; C09D 133/08; B33Y 70/00; B29C 64/112

(52) U.S. Cl. CPC C08L 33/08; B33Y 10/00; C08J 9/0061; C09D 7/65; C09D 4/06; C09D 133/08; B33Y 70/00; B29C 64/112; C08L 2203/14; C08L 2205/14; C08L 2205/025; C08J 2203/22; C08J 2333/08; C08J 2433/08; C08J 9/228

(57) ABSTRACT

Disclosed are polymerizable compositions, methods, and articles and coatings related to multi-polymer networks wherein at least one of the polymer networks is based on particles. In an embodiment, the polymerizable compositions comprise at least two parts: 1) a polymer forming part comprising one or more compounds comprising a polymerizable group, wherein a composition consisting of the polymer forming part, if 90% or more polymerized, has a Tg of less than 25° C. and a prescribed volume average cross-link density at 100° C.; and 2) swellable particles comprising cross-links and having a Tg of less than 25° C. and a prescribed cross-link density. The swellable particles swell to a prescribed swelling ratio by mass from their non-swollen state if the swellable particles are swollen to equilibrium in a mixture consisting of the polymer forming part and the swellable particles.

### CROSS-REFERENCE TO RELATED APPLICATIONS

This application claims priority to European Patent Application EP15188144.8, filed on 2 Oct. 2015, which is hereby incorporated by reference in its entirety.

### FIELD

The field of the invention is polymerizable compositions that may form multi-polymer networks wherein at least one of the polymer networks is based on particles, methods of forming multi-polymer networks wherein at least one of the polymer networks is based on particles, and articles and coatings comprising multi-polymer networks wherein at least one of the polymer networks is based on particles.

### BACKGROUND

An interpenetrating polymer network (IPN) is a material made of more than one polymer network linked primarily by non-covalent interactions, e.g. polymer entanglement on a molecular level, rather than chemical bonds, e.g. covalent bonds. IPNs are distinguishable from single polymer networks, which may be formed from chemically bonding the same or different types of polymers together.

There are various types of IPNs known in the art. One type of IPN is a sequential IPN (SIPN). In a SIPN the second polymer network is formed following the formation of the first polymer network. SIPNs can be made using a variety of techniques. One way of making a SIPN is by starting from a first polymer network, immersing the first polymer network in a liquid composition of monomers, allowing the monomers to penetrate the first polymer network, and then polymerizing the composition of monomers to form a second polymer network that interpenetrates the first polymer network.

A special type of SIPN may be referred to as a multi-network polymer, such as a double network polymer or a triple network polymer. Although some types of multi-networks polymers are SIPNs, it is possible for a multi-network polymer to not be a SIPN or IPN. A multi-network polymer is characterized by at least one polymer network with stretched polymer chains within the multi-network polymer. Relative to other elastomeric IPNs, multi-network polymers have exhibited highly elastic behavior and are often stronger and tougher than their constituent networks individually.

The concept of a double network polymer was first illustrated in 2003 in the form of a double network hydrogel. See Gong, J P, et al. “Double-Network Hydrogels with Extremely High Mechanical Strength.” Adv. Mater. 2003; 15:1155-8. Gong et al. form double network hydrogels by sequentially polymerizing each network from an aqueous solution. Gong et al. report a double network hydrogel containing 60-90 wt % water with a high fracture strength. Gong et al. emphasize that two structural parameters are crucial for obtaining mechanically strong gels: a molar ratio of the second polymer network to the first polymer network in the range of several to a few tens, and the first polymer network being highly cross-linked and the second polymer network being loosely cross-linked.

Double network hydrogels with two-phase composite structures are also known. See Hu, Jian, et al. “Microgel-Reinforced Hydrogel Films with High Mechanical Strength and Their Visible Mesoscale Fracture Structure.” Macromolecules. 2011, 44:7775-7781. Hu et al. form hydrogel films with a two-phase composition structure by embedding densely cross-linked quasi-monodisperse microgels (diameter ca. 5 μm) of various chemical species with different charges into a sparsely cross-linked neutral polyacrylamide matrix. The microgel-reinforced hydrogel films are formed by first trapping the microgels in a first network, swelling the first network, and then forming a second network to truly reinforce the hydrogel. Hu et al. state that these films show a decrease in swelling ratio compared to double network hydrogel films that are not microgel-reinforced, indicating that the microgels act as multifunctional cross-linking points.

Although the majority of literature relating to double network polymers has involved hydrogels, the concept of double network polymers has been applied outside of the hydrogel context, specifically in the context of elastomers. See Ducrot, Etienne, et al. “Double-Network Elastomers.” Polymer Networks Group. Jackson Hole, Wyo., USA. 15 Aug. 2012. Conference Presentation. Ducrot et al. form double network elastomers by sequential polymerization of polymerizable compositions comprising an alkyl acrylate, an initiator, and a solvent. Ducrot et al. report a polymer network that is perfectly elastic with no dissipation.

Further work relating to double and triple network elastomers was presented by Ducrot et al. in 2014. See Ducrot, Etienne, et al. “Toughening Elastomers with Sacrificial Bonds and Watching Them Break.” Science, vol. 344, 11 Apr. 2014. Ducrot et al. form double and triple network elastomers by sequential polymerization of polymerizable compositions comprising an alkyl acrylate, an initiator, and a solvent. The presented polymer multi-networks exhibit toughness and stiffness with less than 6% of residual deformation after strains up to 150%, and negligible viscoelasticity. It is reported that “by varying the volume fraction, monomer type, and cross-linking level of the pre-stretched chains, the properties of the materials can be tuned over a wide range.”

The processes used by Gong et al. and Ducrot et al. to form their multi-network polymers generally follow the following procedure. The first, relatively highly cross-linked polymer network is swelled in a polymerizable composition comprising one or more polymerizable monomers, an initiator, and optionally a solvent. After swelling the first cross-linked polymer network in the polymerizable composition, polymerization is initiated in the polymerizable composition to form a second cross-linked polymer network that is cross-linked to a lesser degree than the first cross-linked polymer network. The result is a second cross-linked polymer network interpenetrated and entangled within the first cross-linked polymer network, a so-called double network polymer. The process may be repeated by swelling the double network polymer in yet another polymerizable composition and polymerizing the polymerizable composition again to form a triple network polymer.

Generally, the first cross-linked polymer network is highly cross-linked and is a weak and brittle material, like most highly cross-linked unfilled elastomers. However, after reinforcing the first cross-linked polymer network with the second cross-linked polymer network as described above, a strong and tough polymer multi-network may be obtained.

### SUMMARY

Past work on multi-network polymers has centered around the bulk polymerization of each polymer network. For example, to produce a suitable molded article, a first cross-linked polymer network would need to be made from a first polymerizable composition present in a mold. The first polymerizable composition comprises a solvent, such as water or toluene. The first cross-linked polymer network would then need to be swelled in a second polymerizable composition, which optionally comprises a solvent. The second polymerizable composition is then polymerized. Additionally, evaporation of solvent may be required.

The inventors have recognized that this technique presents several disadvantages. In the prior art, at least two steps are required to produce articles. First, the first network must be formed into the desired shape. Second, this shape must be swollen with the second polymerizable composition and the second polymerizable composition cured. This second step takes time, thereby limiting processing speed. Moreover, the requisite swelling of the first network limits the control over the accuracy of the final shape.

Another disadvantage is that swelling the first network to equilibrium in the second polymerizable composition may result in an excess of second network in the double network polymer. This may lead to non-uniform properties that manifest in articles exhibiting surface effects resulting from a lack of first network material near the surface of the article.

The inventors have discovered that multi-network polymers may be formed with a certain first polymer network that is disperse and comprises cross-links, provided that the first polymer network swells sufficiently in the certain components that will form the second network polymer. Whereas the prior art has used a continuous, homogenous first polymer network, in embodiments, the invention involves a discontinuous, disperse first polymer network, such as a first polymer network present in the polymerizable composition in the form of particles.

Applying the invention may have various advantages in process speed, customer-side process efficiencies, and advantages in the polymerizable composition used to form the multi-network polymer, such as a reduced viscosity of a polymerizable composition that may form a multi-network polymer. The viscosity level of the polymerizable composition may result in a simplified process to form articles exhibiting properties characteristic of multi-network polymers with higher accuracy and the ability to apply the polymerizable composition as a thin layer. In an embodiment, a polymerizable composition comprises at least two parts: a polymer forming part comprising one or more compounds comprising a polymerizable group, and, optionally, an initiator; and swellable particles comprising cross-links and having a Tg of less than 25° C. and a 1/T₂, as determined by solid state NMR T₂ relaxometry at 110° C. using a Hahn-echo pulse sequence, of from 0.1 ms⁻¹ to 10 ms⁻¹, and wherein the swellable particles swell to a swelling ratio of 250% or more or 300% or more by mass from their non-swollen state if the swellable particles are swollen to equilibrium in a mixture consisting of the polymer forming part and the swellable particles.

The polymer forming part is capable of forming a polymer that at least partially interpenetrates the particles. The swellable particles may be present in an amount of from 5 to 40 wt %, based on the total of the amount of the polymer forming part and the swellable particles. The swellable particles and the polymer forming part are chosen such that the particles swell to a swelling ratio of 250% or more or 300% or more by mass if the swellable particles are swollen to equilibrium in a mixture consisting of the polymer forming part and the swellable particles. Additionally, if a composition consisting of the polymer forming part is 90% or more polymerized, the resulting material has a Tg of less than 25° C. and a volume average cross-link density at 100° C. as determined by DMTA of from 0.005 mol/l to 10 mol/l.

In an embodiment, the polymerizable composition further comprises a solvent, preferably a non-aqueous solvent, and/or a filler. The filler may be organic or inorganic and includes particles that do not fall under the limitations of swellable particles. In an embodiment, the polymerizable composition is substantially devoid of aqueous solvent. In an embodiment the polymerizable composition comprises less than 5 wt % or less of water, based on the total weight of the polymerizable composition.

In an embodiment, a method of forming an article or coating is provided. First, a polymerizable composition as described above is provided. The polymerizable composition is then polymerized, for instance by activating an initiator that may be present in the polymerizable composition. Further methods include methods of forming three-dimensional articles, such as by an additive fabrication technique.

Other embodiments of the invention relate to additional polymerizable compositions, methods of forming articles or coatings, uses, articles, and coatings.

### DETAILED DESCRIPTION

The properties of a multi-network polymer may be generally characterized by its tear strength, its tensile modulus, and a stress at break or maximum stress that is greater than its tensile modulus. In embodiments, double-network polymers show no substantial hysteresis. The prior art has utilized multi-network polymers to achieve a desirable combination of strength, toughness, and elasticity, but via a technique that the inventors realized was cumbersome and ill-suited to certain commercial applications. The inventors have realized that desirable mechanical properties may be achieved for multi-network polymers with a discontinuous, disperse first polymer network within certain parameters. This technique may yield a polymerizable composition already comprising a first network polymer that may be more processable relative to prior art materials.

Furthermore, the invention may provide improvements in process efficiency. In the prior art, the polymerization step that substantially forms the final shape of the multi-network polymer article is the first of two or more polymerization steps. In contrast, in embodiments of the invention, the polymerization step that substantially forms the final shape of the multi-network polymer article is either the second (or later) polymerization step, or the first and final polymerization step. This technique gives the advantage that a single polymerizable composition can be formed at a manufacturing site and then distributed to customers. The customers may then carry out just the steps of forming the shape of the article or coating with the supplied polymerizable composition and polymerizing the supplied polymerizable composition. This is a more efficient process than in the prior art where the customer would need to form the shape of the article or coating with a first polymerizable composition, cure the first polymerizable composition, swell the now polymerized first composition in a second polymerizable composition, and then polymerize the second composition.

Although multi-network polymers have been reportedly formed from polymerizable compositions comprising particles in at least one prior case (See Hu et al., referenced previously), the particles themselves do not form part of the multi-network polymer structure because the particles employed do not swell sufficiently.

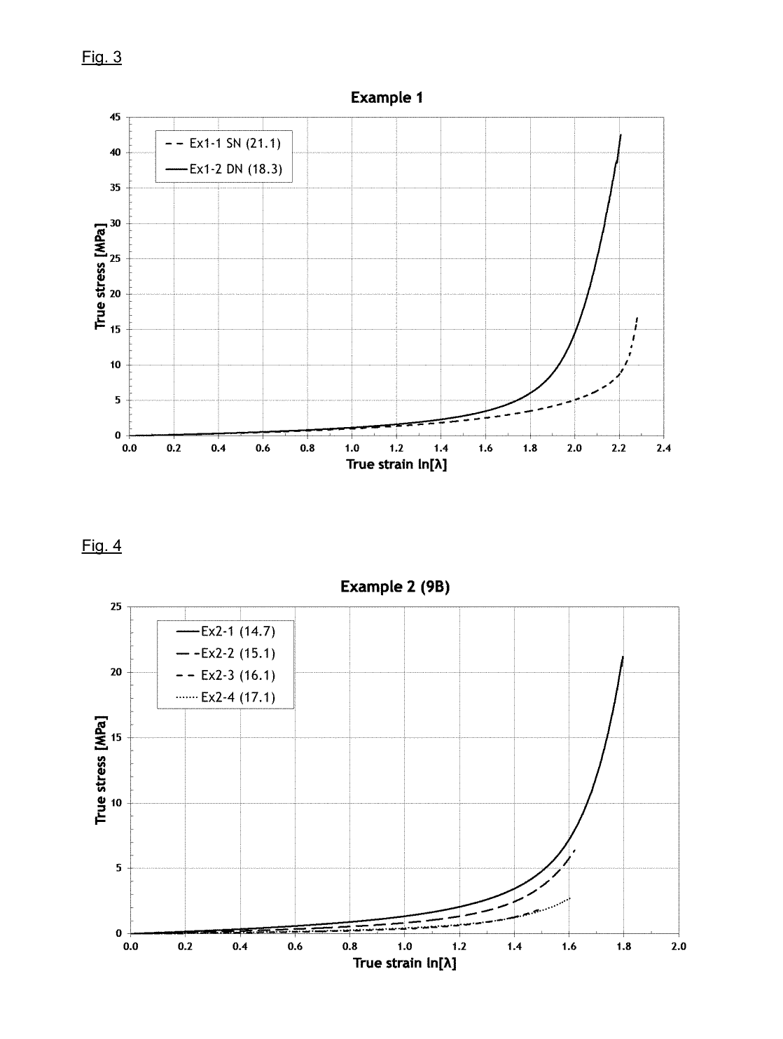

Although Hu et al., combine densely cross-linked quasi-monodisperse microgels with different charges into a sparsely cross-linked neutral polyacrylamide matrix, Hu et al. see substantial hysteresis in these materials. In this regard, Hu et al. report “prominent hysteresis” for the microgel/polyacrylamide matrix alone (See FIG. 2(a) MR(-)0.07 1^{st} elongation and 2^{nd} elongation). Optical analysis of the optical microscopy images present in FIGS. 2(b) and 2(c) of Hu et al. indicate that the particles have only swelled roughly 110-115% by volume, although it is acknowledged that the dyeing of charged groups may slightly reduce swelling of the particles.

In contrast, the inventors discovered that the mechanical properties of such systems are greatly improved when a certain level of particle swelling is attained, along with other parameters of the polymerizable composition. In this regard, an embodiment of a polymerizable composition according to the invention contains swellable particles comprising cross-links that have a certain Tg, cross-link density, and swell to a certain swelling ratio in the polymer forming part of the polymerizable composition.

The use of a hard filler in a rubber is well known to increase the modulus, strength, and toughness of a material. However, for applications where a soft material is desired, the use of a hard filler is often not suitable because the modulus of the material may increase undesirably. In contrast, in embodiments of the invention, the strength and toughness of a material may be increased while keeping the material soft.

Furthermore, the Mullins effect is well known in filled rubbers and is characterized by a softening dependent on the extent of loading encountered in previous deformations. Another potential advantage of the present invention over rubbers filled with hard particles is that, in embodiments of the invention, low-hysteresis behavior may be achieved.

Another potential advantage of the invention is that, in embodiments, an article or coating formed from the polymerizable composition is optically transparent. It is not trivial to make prior art filled rubbers optically transparent. One technique is to use an optically transparent filler, such as silica. Other approaches are to attempt to match the refractive indices of the filler and the rubber (U.S. Pat. No. 3,996,187), but this severely restricts the choice of materials that can be used. Another is to use small enough fillers such that they do not scatter light (U.S. Pat. No. 4,418,165), which then limits the size of the fillers and their aggregates to below a few hundred nm.

In accordance with a first embodiment of the invention, a polymerizable composition comprises at least a polymer forming part and swellable particles. The polymer forming part is the part of the polymerizable composition that is capable of forming a polymer. The swellable particles are swelled by the polymer forming part and may react with the polymer forming part. The polymer forming part does not include any particles or fillers.

In an embodiment, the combined amount of the polymer forming part and swellable particles in the polymerizable composition is at least 20 wt %, at least 30 wt %, at least 40 wt %, at least 50 wt %, at least 60 wt %, at least 70 wt %, at least 80 wt %, at least 90 wt %, or 100 wt % of the total polymerizable composition. In an embodiment, the combined amount of the polymer forming part and swellable particles in the polymerizable composition is at most 98 wt %, at most 95 wt %, at most 90 wt %, at most 80 wt %, at most 70 wt %, or at most 60 wt % of the total polymerizable composition.

The polymer forming part comprises one or more compounds comprising a polymerizable group. The polymerizable groups are polymerizable, such as by free-radical polymerization, cationic polymerization, anionic polymerization, reduction oxidation, addition polymerization, polycondensation, or other known methods. The polymerizable groups may be, for example, hydroxy, amino, sulpho, keto, ester, amide, acid, anhydride, acetoxy, or acetals. In an embodiment, the polymerizable group is selected from the group consisting of hydroxy, amino, epoxy, oxetane, (meth)acrylate, (meth)acrylamide, carboxyl, isocyanate, and vinylether. In an embodiment, more than one different type of polymerizable group is present in the polymer forming part.

The initiator may be any number of compounds depending on the type of polymerizable groups present. Preferred initiators are photoinitiators and thermal initiators. Examples of photoinitiators are free-radical photoinitiators and cationic photoinitiators. Examples of thermal initiators are peroxides, azo compounds, and persulfates.

In an embodiment, the polymer forming part comprises one or more components comprising one (meth)acrylate group, one or more components comprising more than one (meth)acrylate group, and a photoinitiator. In an embodiment, the polymer forming part comprises one or more components comprising more than one (meth)acrylate group and a photoinitiator. In an embodiment, the polymer forming part comprises one or more components comprising one (meth)acrylate group, one or more components comprising more than one (meth)acrylate group, and a thermal initiator. In an embodiment, the polymer forming part comprises one or more components comprising more than one (meth)acrylate group and a thermal initiator.

The polymer forming part, if 90% or more polymerized in the absence of any other materials (i.e. a composition consisting of the polymer forming part), has a Tg of less than 25° C., such as from −130° C. to 25° C., as measured by DMTA as described in the Examples section.

The polymer forming part, if 90% or more polymerized in the absence of any other materials (i.e. a composition consisting of the polymer forming part), has a volume average cross-link density at 100° C. of 10 mol/l or less, 5.0 mol/l or less, 3.0 mol/l or less, 1.0 mol/l, or less, 0.5 mol/l, 0.2 mol/l or less, 0.16 mol/l or less, 0.15 mol/l or less, 0.13 mol/l or less, 0.12 mol/l or less, 0.115 mol/l or less, 0.11 mol/l or less, 0.1 mol/l or less, 0.085 mol/l or less, or 0.075 mol/l or less, such as from 0.005 mol/l to 10 mol/l, from 0.005 mol/l to 5.0 mol/l, from 0.005 mol/l to 3.0 mol/l, from 0.005 mol/l to 1.0 mol/l, from 0.005 mol/l to 0.5 mol/l, 0.005 mol/l to 0.2 mol/l, from 0.005 mol/l to 0.16 mol/l, from 0.005 mol/l to 0.15 mol/l, from 0.005 mol/l to 0.13 mol/l, from 0.005 mol/l to 0.12 mol/l, from 0.005 mol/l to 0.115 mol/l, from 0.005 mol/l to 0.11 mol/l, from 0.005 mol/l to 0.1 mol/l, from 0.005 mol/l to 0.085 mol/l, or from 0.005 mol/l to 0.075 mol/l. The volume average cross-link density is determined experimentally by DMTA and is calculated using the following equation 1:

$$v = \frac{{E}^{′}}{3 RT} \qquad ( 1 )$$

wherein v is the volume average cross-link density, R is the gas constant in J·K⁻¹·mol⁻¹, T is the temperature in K, and E′ is the storage modulus in Pa as determined by DMTA. A unit conversion may then be necessary to obtain v in mol/l. The storage modulus is measured by DMTA using the procedure described in the Examples section. All volume average cross-link densities v for the polymer forming part are reported at 100° C. Therefore, v is calculated using the above equation with T=373.15 K, and the storage modulus (E′) as measured at 100° C.

The amount that the polymer forming part is polymerized is determined using IR by the following method. Samples are measured on a Perkin Elmer Spectrum One equipped with a Universal ATR Sampling accessory. Peak heights are normalized to the carbonyl peak at 1727 cm⁻¹, or another peak that does not change. Conversion is calculated using the following formula: % conversion=((A₀−Aₜ)/A₀)*100%, wherein A₀ is the normalized absorbance prior to cure and Aₜ is the normalized absorbance during curing. For example, conversion of acrylate bonds may be measured by following the decrease of IR absorbance peak at 810 cm⁻¹.

In accordance with a first embodiment of the invention, a polymerizable composition comprises swellable particles, the swellable particles comprising cross-links. The cross-links may be chemical cross-links and/or physical entanglements, but some degree of chemical cross-linking is preferred. The swellable particles may comprise one or more types of polymers, such as homopolymers, random co-polymers, block-copolymers, diblock-copolymers, triblock-copolymers, alternating copolymers, branched copolymers, gradient copolymers, and combinations thereof. Preferably, the swellable particles comprise a polymer selected from polyesters, polyamides, polysiloxanes such as polydimethylsiloxanes, polycarbonates, polyurethanes, vinyl polymers, polyacrylates, polymethacrylates, polyolefins, polybutadiene, styrene-butadiene rubber (SBR), nitrile butadiene rubber (NBR), or a combination thereof.

Other swellable particles may be polybutadiene, polyisoprene, styrene/butadiene random copolymer, styrene/isoprene random copolymer, acrylic rubbers (e.g. polybutylacrylate), poly(hexamethylene carbonate), polysiloxane, ethylene/acrylate random copolymers and acrylic block copolymers, styrene/butadiene/(meth)acrylate (SBM) block-copolymers, styrene/butadiene block copolymer (styrene-butadiene-styrene block copolymer (SBS), styrene-isoprene-styrene block copolymer (SIS), their hydrogenated versions such as SEBS and, SEPS, and ionomers. An example of an ionomer is a copolymer of ethylene and acrylic acid cross-linked with a metal ion, such as of Mg or Zn. A commercial ionomer is DuPont™ Surlyn®.

Optionally, a shell may be present. The shell may be introduced via grafting or during a second stage of emulsion polymerization. Examples of such particles are core-shell impact modifier particles that contain a rubber core and a glassy shell. Examples of core materials are polybutadiene, polyisoprene, acrylic rubber (e.g. polybutylacrylate rubber), styrene/butadiene random copolymer, styrene/isoprene random copolymer, or polysiloxane. Examples of shell materials or graft copolymers are (co)polymers of vinyl aromatic compounds (e.g. styrene) and vinyl cyanides (e.g. acrylonitrile) or (meth)acrylates (e.g. methyl methacrylate). Swellable particles comprising a shell may exhibit two Tgs: one from the rubbery core that is less than 25° C. and one based on the glassy shell, which may be 25° C. or higher.

In an embodiment, the swellable particles are polydimethylsiloxane particles. The swellable particles may be formed by anionic polymerization of siloxane monomers with the aid of an appropriate initiator, for example potassium butoxide, followed by grinding. In an embodiment, the swellable particles are cross-linked polyorganosiloxane rubbers that may include dialkylsiloxane repeating units, where “alkyl” is C₁-C₆ alkyl. Examples of such particles are Albidur® products from Evonik.

The swellable particles can be made by various suitable processes. The particles may be formed by polymerizing a particle composition, such as via free-radical polymerization, cationic polymerization, anionic polymerization, reduction oxidation, addition polymerization, polycondensation, or other known methods, and in the presence of appropriate solvents and surfactants. The particles may also be formed by the cross-linking of particles that have been formed via an emulsion polymerization. Further potential methods for making particles include solution precipitation, spray-drying, coagulation, milling, and grinding techniques such as cryogenic grinding.

In an embodiment, the swellable particles are formed from a particle composition as an emulsion in a dispersing medium comprising 50 wt % or more of dispersing medium (for example, water), based on the total weight of the particle composition and the dispersing medium. The particle composition is then cross-linked to form the swellable particles suspended in the dispersing medium. The swellable particles, the dispersing medium, and a polymer forming part are then mixed to form a polymerizable composition. The dispersing medium may be present at an amount of from 20 to 80 wt %, the swellable particles may be present at an amount of from 8 to 40 wt %, and the polymer forming part may be present at an amount of from 10 to 40 wt %, all based on the total weight of the polymerizable composition. Optionally, the polymerizable composition comprises a solvent. The dispersing medium may comprise 50 wt % or more of water, based on the total weight of the polymerizable composition. The polymerizable composition may comprise the water that was present when forming the swellable particles. In the case that the water present when forming the swellable particles is present in the polymerizable composition, the polymer forming part is preferably emulsified in the dispersing medium. In another embodiment, the polymer forming part may be separately emulsified in a dispersing medium and then this emulsion is added to the mixture comprising the swellable particles and the dispersing medium. An article or coating may be formed by polymerizing the polymerizable composition and, if necessary, evaporating the solvent and/or the dispersing medium.

Accordingly, in an embodiment the polymerizable composition is formed by the steps comprising providing the swellable particles dispersed in a dispersing medium, and forming the polymerizable composition by emulsifying the polymer forming part in the dispersing medium. Some or all of the polymer forming part may be emulsified in the dispersing medium.

In an embodiment, the swellable particles are made by polymerizing a particle composition. In an embodiment, the swellable particles comprise a (meth)acrylate polymer. The (meth)acrylate polymer may be formed by polymerizing a particles composition comprising (meth)acrylate monomers. The particle composition is preferably a liquid composition that can be polymerized to form a solid. Once the particle composition is polymerized it may yield the swellable particles directly, such as in the form of a latex, or it may yield a larger form from which swellable particles may be obtained by additional operations, such as by grinding from a block of material. Depending on the chosen method of forming swellable particles, the particle composition may comprise a suitable solvent. Examples of such solvents are alcohols, ketones, esters, ethers, and/or water.

The swellable particles have a Tg of less than 25° C., such as from −130° C. to 25° C., as measured by Dynamic Mechanical Thermal Analysis (DMTA), which is described in the Examples section. To test the Tg of swellable particles, the swellable particles are first dried in air until they form a film. After forming a film, the film is dried for 16 hours in a vacuum oven at 80° C. The Tg is the peak loss modulus (E″) as measured using DMTA. If the particles do not film a film, they are assumed to have a Tg of 25° C. or higher.

In an embodiment, the swellable particles have an average particle diameter of from 1 nm to 1 mm in diameter, such as from 10 nm to 800 μm, such as from 10 nm to 500 μm, from 10 nm to 10 μm, or from 10 nm to 3 μm. Particles with an average particle diameter below 3 μm are measured using photon correlation spectroscopy (PCS) in accordance with ISO13321:1996, using the procedure described in the Examples. For average particle diameters of from 3 μm to 20 μm, cryo-TEM (cryogenic transmission electron microscopy) is used to measure average particle diameter. Above 20 μm, the average particle diameter is measured using optical microscopy.

The swellable particles have a prescribed volume average cross-link density. As demonstrated in the Examples, volume average cross-link density corresponds with a relaxation rate 1/T₂, as determined by ¹H NMR T₂ relaxometry using a Hahn-echo pulse sequence (HEPS) at 110° C., where T₂ is the time at which the signal amplitude has decayed to 1/e (approximately 36.8%) of its original value. In an embodiment, the swellable particles have a 1/T₂ of 0.1 ms⁻¹ or more, 0.2 ms⁻¹ or more, 0.3 ms⁻¹ or more, 0.4 ms⁻¹ or more, 0.5 ms⁻¹ or more, 0.6 ms⁻¹ or more, 0.7 ms⁻¹ or more, or 0.8 ms⁻¹ or more. In an embodiment, the swellable particles have a 1/T₂ of from 0.1 ms⁻¹ to 10 ms⁻¹, from 0.2 ms⁻¹ to 10 ms⁻¹, from 0.3 ms⁻¹ to 10 ms⁻¹, from 0.4 ms⁻¹ to 10 ms⁻¹, from 0.5 ms⁻¹ to 10 ms⁻¹, from 0.6 ms⁻¹ to 10 ms⁻¹, from 0.7 ms⁻¹ to 10 ms⁻¹, or from 0.8 ms⁻¹ to 10 ms⁻¹. In an embodiment, the swellable particles have a 1/T₂ of from 0.1 ms⁻¹ to 5 ms⁻¹, from 0.2 ms⁻¹ to 5 ms⁻¹, from 0.3 ms⁻¹ to 5 ms⁻¹, from 0.4 ms⁻¹ to 5 ms⁻¹, from 0.5 ms⁻¹ to 5 ms⁻¹, from 0.6 ms⁻¹ to 5 ms⁻¹, from 0.7 ms⁻¹ to 5 ms⁻¹, or from 0.8 ms⁻¹ to 5 ms⁻¹.

In an embodiment, the swellable particles have a volume average cross-link density (v) as measured by DMTA on a film formed by curing the particle composition such that 90% or more of the polymerizable groups in the particle composition are polymerized of 0.01 mol/l or more, 0.025 mol/l or more, 0.05 mol/l or more, 0.1 mol/l or more, 0.20 mol/l or more, 0.275 mol/l or more, 0.5 mol/l or more, 0.75 mol/l or more, or 1.0 mol/l or more. The DMTA procedure to determine the volume average cross-link density is the same as for determining the volume average cross-link density of the polymer forming part. In an embodiment, the swellable particles have a volume average cross-link density (v) as measured by DMTA on a film formed by curing the particle composition such that 90% or more of the polymerizable groups in the particle composition are polymerized of 10 mol/l or less, 7 mol/l or less, or 5.5 mol/l or less. In an embodiment, the swellable particles have a volume average cross-link density (v) as measured by DMTA on a film formed by curing the particle composition such that 90% or more of the polymerizable groups in the particle composition are polymerized of from 0.01 to 10 mol/l, from 0.025 to 10 mol/l, from 0.05 g/mol to 10 mol/l, from 0.1 to 10 mol/l, from 0.2 to 10 mol/l, from 0.275 to 10 mol/l, from 0.5 to 10 mol/l, from 0.75 to 10 mol/l, or from 1.0 to 10 mol/l. In an embodiment, the swellable particles have a volume average cross-link density (v) as measured by DMTA on a film formed by curing the particle composition such that 90% or more of the polymerizable groups in the particle composition are polymerized of from 0.01 to 7 mol/l, from 0.025 to 7 mol/l, from 0.05 g/mol to 7 mol/l, from 0.1 to 7 mol/l, from 0.2 to 7 mol/l, from 0.275 to 7 mol/l, from 0.5 to 7 mol/l, from 0.75 to 7 mol/l, or from 1.0 to 7 mol/l. In an embodiment, the swellable particles have a volume average cross-link density (v) as measured by DMTA on a film formed by curing the particle composition such that 90% or more of the polymerizable groups in the particle composition are polymerized from 0.01 to 5.5 mol/l, from 0.025 to 5.5 mol/l, from 0.05 g/mol to 5.5 mol/l, from 0.1 to 5.5 mol/l, from 0.2 to 5.5 mol/l, from 0.275 to 5.5 mol/l, from 0.5 to 5.5 mol/l, from 0.75 to 5.5 mol/l, or from 1.0 to 5.5 mol/l.

The polymer forming part and the swellable particles are selected such that the swellable particles swell to a swelling ratio of 250% or more or 300% or more by mass when the swellable particles are present in a composition consisting of the swellable particles and the polymer forming part. In an embodiment, the swellable particles are swollen to a swelling ratio of 250% or more, 300% or more, 325% or more, 350% or more, 375% or more, 400% or more, or 425% or more by mass when the swellable particles are present in a composition consisting of the swellable particles and the polymer forming part. In an embodiment, the swellable particles are swollen to a swelling ratio of 5000% or less, 2500% or less, or 1500% or less by mass when the swellable particles are present in a composition consisting of the swellable particles and the polymer forming part. In an embodiment, the swellable particles are swollen to a swelling ratio of from 250% to 5000%, 300% to 5000%, from 325% to 5000%, from 350% to 5000%, from 375% to 5000%, from 400% to 5000%, or from 425% to 5000% by mass when the swellable particles are present in a composition consisting of the swellable particles and the polymer forming part. In an embodiment, the swellable particles are swollen to a swelling ratio of from 250% to 2500%, 300% to 2500%, from 325% to 2500%, from 350% to 2500%, from 375% to 2500%, from 400% to 2500%, or from 425% to 2500% by mass when the swellable particles are present in a composition consisting of the swellable particles and the polymer forming part. In an embodiment, the swellable particles are swollen to a swelling ratio of from 250% to 1500%, 300% to 1500%, from 325% to 1500%, from 350% to 1500%, from 375% to 1500%, from 400% to 1500%, or from 425% to 1500% by mass when the swellable particles are present in a composition consisting of the swellable particles and the polymer forming part.

The swelling ratio is determined as follows. A sample of swellable particles are dried into a film, weighed (m₁), and placed in a small aluminum cup of known weight. An amount of polymer forming part sufficient to cover the sample of swellable particles is added to the aluminum cup. The sample is allowed to swell to equilibrium, meaning the sample is allowed to swell to a point where the sample cannot gain any more volume. Typically, the sample is allowed to swell for 48 hours. The excess of polymer forming part is then carefully removed and the remaining swollen particles are weighed (m₂). Depending on the size of the swollen particles, a sieve, a syringe fitted with a filter, or merely a pipette may be used to remove substantially all excess of the polymer forming part. The swelling ratio is determined by the following equation: % swelling=(m₂−m₁)/m₁.

In an embodiment, the one or more compounds comprising a polymerizable group in the polymer forming part comprises at least 50 wt %, 60 wt %, 70 wt %, 80 wt %, 90 wt %, or 95 wt %, based on the total weight of the compounds comprising a polymerizable group in the polymer forming part, of compounds that have a molar mass of 700 g/mol or less, 650 g/mol or less, 600 g/mol or less, 550 g/mol or less, 500 g/mol or less, 450 g/mol or less, 400 g/mol or less, 350 g/mol or less, or 300 g/mol or less, such as from 70 to 700 g/mol, from 70 to 650 g/mol, from 70 to 600 g/mol, from 70 to 550 g/mol, from 70 to 500 g/mol, from 70 to 450 g/mol, from 70 to 400 g/mol, from 70 to 350 g/mol, or from 70 to 300 g/mol.

In an embodiment, the polymerizable composition has a viscosity of from 0.01 to 3000 Pa-s at 25° C. In an embodiment, the polymerizable composition has a viscosity of from 0.01 to 2500 Pa-s at 25° C. or from 0.01 to 2000 Pa-s at 25° C. The viscosity of a formulation is measured using a Paar Physica LC3 Viscometer operating at a shear rate of 50 s−1 and using a Z3 cup, utilizing 14-16 g of material per measurement. All viscosity measurements are performed with the viscometer/sample equilibrated to 25° C.

In an embodiment, the swellable particles comprise a surface functionality. The surface functionality may comprise a polymerizable group. The surface functionality may be selected for compatibility with the polymer forming part. In an embodiment, the polymerizable groups are polymerizable, such as by free-radical polymerization, cationic polymerization, anionic polymerization, reduction oxidation, addition polymerization, polycondensation, or other known methods. The polymerizable groups may be hydroxy, amino, sulpho, keto, ester, amide, acid, anhydride, acetoxy, or acetals. In an embodiment, the swellable particles comprise a surface functionality selected from the group consisting of hydroxy, amino, epoxy, oxetane, (meth)acrylate, (meth)acrylamide, carboxyl, and vinylether.

In an embodiment, the swellable particles are present in an amount of from 3 to 40 wt %, based on the total amount of the swellable particles and the polymer forming part in the polymerizable composition, or in an amount of from 5 to 40 wt %, from 8 to 40 wt %, or from 8 to 35 wt %, from 8 to 30 wt %, or from 3 to 25 wt %, from 5 to 25 wt %, or from 8 to 25 wt %.

In embodiments, the polymer forming part, the particle composition, or both comprises one or more components comprising one polymerizable group, one or more components comprising two or more polymerizable groups, and an initiator. In embodiments, the polymer forming part, the particle composition, or both comprises one or more components comprising two or more polymerizable groups and an initiator. The initiator is preferably a photoinitiator or a thermal initiator.

In embodiments, the polymer forming part, the particle composition, or both comprises one or more components comprising one free-radical polymerizable group, one or more components comprising two or more free-radical polymerizable groups, and a free-radical photoinitiator. In embodiments, the polymer forming part, the particle composition, or both comprises one or more components comprising two or more free-radical polymerizable groups and a free-radical photoinitiator. In embodiments, the polymer forming part, the particle composition, or both comprises one or more components comprising one free-radical polymerizable group, one or more components comprising two or more free-radical polymerizable groups, and a free-radical thermal initiator. In embodiments, the polymer forming part, the particle composition, or both comprises one or more components comprising two or more free-radical polymerizable groups and a free-radical thermal initiator.

In embodiments, the polymer forming part, the particle composition, or both comprises one or more components comprising one (meth)acrylate group, one or more components comprising two or more (meth)acrylate groups, and a photoinitiator. In embodiments, the polymer forming part, the particle composition, or both comprises one or more components comprising two or more (meth)acrylate groups and a photoinitiator. In embodiments, the polymer forming part, the particle composition, or both comprises one or more components comprising one (meth)acrylate group, one or more components comprising two or more (meth)acrylate groups, and a thermal initiator. In embodiments, the polymer forming part, the particle composition, or both comprises one or more components comprising two or more (meth)acrylate groups and a thermal initiator.

Below are described various components that may be present in the polymer forming part, the particle composition that is used to form the swellable particles, or both. Unless noted otherwise, the wt % of all components is given based on the total weight of the polymer forming part or particle composition, as applicable, unless clearly stated otherwise. In the case that the wt % is applicable to the polymer forming part, the wt % is based on the total weight of the polymer forming part. In the case that the wt % is applicable to the particle composition, the wt % is based on the total dry weight of the particle composition (excluding any solvents or dispersing medium).

### Free-Radical Polymerizable Component

In an embodiment, the polymer forming part, the particle composition, or both comprises at least one free-radical polymerizable component, that is, a component which undergoes polymerization initiated by free radicals. The free-radical polymerizable components are monomers, oligomers, and/or polymers; they are monofunctional or polyfunctional materials, i.e., have 1, 2, 3, 4, 5, 6, 7, 8, 9, 10, 20, 30, 40, 50, 100, or more functional groups that can polymerize by free radical initiation, may contain aliphatic, aromatic, cycloaliphatic, arylaliphatic, each of which may comprise one or more heteroatoms, or any combination thereof.

In accordance with an embodiment of the invention, the polymer forming part, the particle composition, or both comprises a component comprising at least one polymerizable (meth)acrylate group. Examples of components comprising at least one polymerizable (meth)acrylate group include acrylates and methacrylates such as isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloyl morpholine, (meth)acrylic acid, 2-hydroxyethyl (meth)acrylate, 2-hydroxypropyl (meth)acrylate, 2-hydroxybutyl (meth)acrylate, hydroxy methyl acrylate, hydroxy isopropyl acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, caprolactone acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, tridecyl (meth)acrylate, undecyl (meth)acrylate, lauryl (meth)acrylate, tetradecyl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, 2-(2-ethoxyethoxy) ethyl acrylate, acetoacetoxy (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, beta-carboxyethyl (meth)acrylate, phthalic acid (meth)acrylate, dimethylaminoethyl (meth)acrylate, 3-(dimethylamino)pentyl acrylate, diethylaminoethyl (meth)acrylate, butylcarbamylethyl (meth)acrylate, n-isopropyl (meth)acrylamide fluorinated (meth)acrylate, 7-amino-3,7-dimethyloctyl (meth)acrylate, 2-(phenylthio)ethyl acrylate, and nonyl phenol acrylate.

Examples of components comprising more than one (meth)acrylate group include those with (meth)acryloyl groups such as trimethylolpropane tri(meth)acrylate, pentaerythritol (meth)acrylate, ethylene glycol di(meth)acrylate, bisphenol A diglycidyl ether di(meth)acrylate, dicyclopentadiene dimethanol di(meth)acrylate, [2-[1,1-dimethyl-2-[(1-oxoallyl)oxy]ethyl]-5-ethyl-1,3-dioxan-5-yl]methyl acrylate; 3,9-bis(1,1-dimethyl-2-hydroxyethyl)-2,4,8,10-tetraoxaspiro[5.5]undecane di(meth)acrylate; dipentaerythritol monohydroxypenta(meth)acrylate, propoxylated trimethylolpropane tri(meth)acrylate, ethoxylated trimethylolpropane tri(meth)acrylate, propoxylated neopentyl glycol di(meth)acrylate, tetraethylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, polybutanediol di(meth)acrylate, tripropyleneglycol di(meth)acrylate, glycerol tri(meth)acrylate, phosphoric acid mono- and di(meth)acrylates, C₇-C₂₀ alkyl di(meth)acrylates, tris(2-hydroxyethyl)isocyanurate tri(meth)acrylate, tris(2-hydroxyethyl)isocyanurate di(meth)acrylate, pentaerythritol tri(meth)acrylate, pentaerythritol tetra(meth)acrylate, dipentaerythritol hexa(meth)crylate, tricyclodecane diyl dimethyl di(meth)acrylate and alkoxylated versions (e.g., ethoxylated and/or propoxylated) of any of the preceding monomers, and also di(meth)acrylate of a diol which is an ethylene oxide or propylene oxide adduct to bisphenol A, di(meth)acrylate of a diol which is an ethylene oxide or propylene oxide adduct to hydrogenated bisphenol A, epoxy (meth)acrylate which is a (meth)acrylate adduct to bisphenol A of diglycidyl ether, diacrylate of polyoxyalkylated bisphenol A, and triethylene glycol divinyl ether, and adducts of hydroxyethyl acrylate.

In accordance with an embodiment, the component comprising at least one polymerizable (meth)acrylate group may include all methacrylate groups, all acrylate groups, or any combination of methacrylate and acrylate groups.

In an embodiment, the free-radical polymerizable component is selected from the group consisting of bisphenol A diglycidyl ether di(meth)acrylate, ethoxylated or propoxylated bisphenol A or bisphenol F di(meth)acrylate, dicyclopentadiene dimethanol di(meth)acrylate, [2-[1,1-dimethyl-2-[(1-oxoallyl)oxy]ethyl]-5-ethyl-1,3-dioxan-5-yl]methyl acrylate, dipentaerythritol monohydroxypenta(meth)acrylate, dipentaerythritol hexa(meth)crylate, propoxylated trimethylolpropane tri(meth)acrylate, and propoxylated neopentyl glycol di(meth)acrylate, and any combination thereof.

The polymer forming part, the particle composition, or both can include any suitable amount of the component comprising at least one polymerizable (meth)acrylate group, for example, in embodiments, in an amount up to 99.99 wt %, up to 99 wt %, or in embodiments, up to 95 wt %. In embodiments, the free-radical polymerizable component is present in an amount of from 30 to 99.99 wt %, in embodiments, from 40 to 99 wt %, and in further embodiments from 45 wt % to 99.5 wt %.

### Free-Radical Polymerization Initiator

In the case that the polymer forming part, the particle composition, or both comprises a free-radical polymerizable component, the polymer forming part, the particle composition, or both may also comprise a free-radical polymerization initiator. Preferred examples of free-radical polymerization initiators are thermal initiators and photoinitiators. Preferably, the free-radical polymerization initiator is a free-radical photoinitiator.

In accordance with an embodiment, the polymer forming part, the particle composition, or both comprises at least one free-radical photoinitiator, e.g., those selected from the group consisting of benzoylphosphine oxides, aryl ketones, benzophenones, hydroxylated ketones, I-hydroxyphenyl ketones, ketals, metallocenes, and any combination thereof.

In an embodiment, the polymer forming part, the particle composition, or both includes at least one free-radical photoinitiator selected from the group consisting of 2,4,6-trimethylbenzoyl diphenylphosphine oxide and 2,4,6-trimethylbenzoyl phenyl, ethoxy phosphine oxide, bis(2,4,6-trimethylbenzoyl)-phenylphosphineoxide, 2-methyl-1-[4-(methylthio)phenyl]-2-morpholinopropanone-1, 2-benzyl-2-(dimethylamino)-1-[4-(4-morpholinyl) phenyl]-1-butanone, 2-dimethylamino-2-(4-methyl-benzyl)-1-(4-morpholin-4-yl-phenyl)-butan-1-one, 4-benzoyl-4′-methyl diphenyl sulphide, 4,4′-bis(diethylamino) benzophenone, and 4,4′-bis(N,N′-dimethylamino) benzophenone (Michler's ketone), benzophenone, 4-methyl benzophenone, 2,4,6-trimethyl benzophenone, dimethoxybenzophenone, I-hydroxycyclohexyl phenyl ketone, phenyl (1-hydroxyisopropyl)ketone, 2-hydroxy-1-[4-(2-hydroxyethoxy) phenyl]-2-methyl-1-propanone, 4-isopropylphenyl(1-hydroxyisopropyl)ketone, oligo-[2-hydroxy-2-methyl-1-[4-(1-methylvinyl)phenyl] propanone], camphorquinone, 4,4′-bis(diethylamino) benzophenone, benzil dimethyl ketal, bis(eta 5-2-4-cyclopentadien-1-yl) bis[2,6-difluoro-3-(1H-pyrrol-1-yl) phenyl] titanium, and any combination thereof.

Further suitable free-radical photoinitiators include: benzoylphosphine oxides, such as, for example, 2,4,6-trimethylbenzoyl diphenylphosphine oxide (Lucirin TPO from BASF) and 2,4,6-trimethylbenzoyl phenyl, ethoxy phosphine oxide (Lucirin TPO-L from BASF), bis(2,4,6-trimethylbenzoyl)-phenylphosphineoxide (Irgacure 819 or BAPO from Ciba), 2-methyl-1-[4-(methylthio)phenyl]-2-morpholinopropanone-1 (Irgacure 907 from Ciba), 2-benzyl-2-(dimethylamino)-1-[4-(4-morpholinyl) phenyl]-1-butanone (Irgacure 369 from Ciba), 2-dimethylamino-2-(4-methyl-benzyl)-1-(4-morpholin-4-yl-phenyl)-butan-1-one (Irgacure 379 from Ciba), 4-benzoyl-4′-methyl diphenyl sulphide (Chivacure BMS from Chitec), 4,4′-bis(diethylamino) benzophenone (Chivacure EMK from Chitec), 4,4′-bis(N,N′-dimethylamino) benzophenone (Michler's ketone), camphorquinone, 4,4′-bis(diethylamino) benzophenone (Chivacure EMK from Chitec), 4,4′-bis(N,N′-dimethylamino) benzophenone (Michler's ketone), bis(2,4,6-trimethylbenzoyl)-phenylphosphineoxide (Irgacure 819 or BAPO from Ciba), and metallocenes such as bis (eta 5-2-4-cyclopentadien-1-yl) bis [2,6-difluoro-3-(1H-pyrrol-1-yl) phenyl] titanium (Irgacure 784 from Ciba). Also suitable are mixtures thereof.

The polymer forming part, the particle composition, or both can include any suitable amount of the free-radical photoinitiator, for example, in certain embodiments, in an amount up to 15 wt %, in embodiments, up to 10 wt %, and in further embodiments from 0.01 wt % to 8 wt %. In other embodiments, the amount of free-radical photoinitiator is present in an amount of from 0.001 wt % to 5 wt %, 0.01 wt % to 5 wt %, or from 0.05 wt % to 5 wt %.

### Cationically Polymerizable Component

In an embodiment, the polymer forming part, the particle composition, or both comprises at least one cationically polymerizable component, that is, a component which undergoes cationic polymerization. The cationically polymerizable component may be selected from the group consisting of cyclic ether compounds, cyclic acetal compounds, cyclic thioethers compounds, spiro-orthoester compounds, cyclic lactone compounds, and vinyl ether compounds, and any combination thereof.

Examples of cationically polymerizable components include cyclic ether compounds such as epoxy compounds, oxetane compounds, cyclic lactone compounds, cyclic acetal compounds, cyclic thioether compounds, spiro orthoester compounds, and vinylether compounds. Specific examples of cationically polymerizable components include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)-cyclohexane-1,4-dioxane, bis(3,4-epoxycyclohexylmethyl)adipate, vinylcyclohexene oxide, 4-vinylepoxycyclohexane, vinylcyclohexene dioxide, limonene oxide, limonene dioxide, bis(3,4-epoxy-6-methylcyclohexylmethyl)adipate, 3,4-epoxy-6-methylcyclohexyl-3′,4′-epoxy-6′-methylcyclohexanecarboxylate, ε-caprolactone-modified 3,4-epoxycyclohexylmethyl-3′,4′-epoxycyclohexane carboxylates, trimethylcaprolactone-modified 3,4-epoxycyclohexylmethyl-3′,4′-epoxycyclohexane carboxylates, β-methyl-δ-valerolactone-modified 3,4-epoxycyclohexcylmethyl-3′,4′-epoxycyclohexane carboxylates, methylenebis(3,4-epoxycyclohexane), bicyclohexyl-3,3′-epoxide, bis(3,4-epoxycyclohexyl) with a linkage of —O—, —S—, —SO—, —SO₂—, —C(CH₃)₂—, —CBr₂—, —C(CBr₃)₂—, —C(CF₃)₂—, —C(CCl₃)₂—, or —CH(C₆H₅)—, dicyclopentadiene diepoxide, di(3,4-epoxycyclohexylmethyl) ether of ethylene glycol, ethylenebis(3,4-epoxycyclohexanecarboxylate), epoxyhexahydrodioctylphthalate, epoxyhexahydro-di-2-ethylhexyl phthalate, 1,4-butanediol diglycidyl ether, 1,6-hexanediol diglycidyl ether, neopentylglycol diglycidyl ether, glycerol triglycidyl ether, trimethylolpropane triglycidyl ether, polyethylene glycol diglycidyl ether, polypropylene glycol diglycidyl ether, polyglycidyl ethers of polyether polyol obtained by the addition of one or more alkylene oxides to aliphatic polyhydric alcohols such as ethylene glycol, propylene glycol, and glycerol, diglycidyl esters of aliphatic long-chain dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, epoxidated soybean oil, epoxybutylstearic acid, epoxyoctylstearic acid, epoxidated linseed oil, epoxidated polybutadiene, 1,4-bis[(3-ethyl-3-oxetanylmethoxy)methyl]benzene, 3-ethyl-3-hydroxymethyloxetane, 3-ethyl-3-(3-hydroxypropyl)oxymethyloxetane, 3-ethyl-3-(4-hydroxybutyl)oxymethyloxetane, 3-ethyl-3-(5-hydroxypentyl)oxymethyloxetane, 3-ethyl-3-phenoxymethyloxetane, bis((1-ethyl(3-oxetanyl))methyl)ether, 3-ethyl-3-((2-ethylhexyloxy)methyl)oxetane, 3-ethyl-((triethoxysilylpropoxymethyl)oxetane, 3-(meth)-allyloxymethyl-3-ethyloxetane, (3-ethyl-3-oxetanylmethoxy) methylbenzene, 4-fluoro-[1-(3-ethyl-3-oxetanylmethoxy)methyl]benzene, 4-methoxy-[1-(3-ethyl-3-oxetanylmethoxy) methyl]-benzene, [1-(3-ethyl-3-oxetanylmethoxy)ethyl]phenyl ether, isobutoxymethyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene (3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, and any combination thereof.

Examples of polyfunctional materials that are cationically polymerizable include dendritic polymers such as dendrimers, linear dendritic polymers, dendrigraft polymers, hyperbranched polymers, star branched polymers, and hypergraft polymers with epoxy or oxetane functional groups. The dendritic polymers may contain one type of polymerizable functional group or different types of polymerizable functional groups, for example, epoxy and oxetane functions.

The polymer forming part, the particle composition, or both may include any suitable amount of cationically polymerizable component, for example, in embodiments, in an amount up to 99.99 wt %, in embodiments, up to 99 wt %, and in further embodiments up to 95 wt %. In embodiments, the cationically polymerizable component is present in an amount of from 30 to 99.99 wt %, in embodiments, from 40 to 99 wt %, and in further embodiments from 45 wt % to 95 wt %.

### Cationic Photoinitiator

In accordance with an embodiment, the polymer forming part, the particle composition, or both includes a cationic photoinitiator. The cationic photoinitiator initiates cationic ring-opening polymerization upon irradiation with light.

In an embodiment, any suitable cationic photoinitiator can be used, for example, those with cations selected from the group consisting of onium salts, halonium salts, iodosyl salts, selenium salts, sulfonium salts, sulfoxonium salts, diazonium salts, metallocene salts, isoquinolinium salts, phosphonium salts, arsonium salts, tropylium salts, dialkylphenacylsulfonium salts, thiopyrilium salts, diaryl iodonium salts, triaryl sulfonium salts, ferrocenes, di(cyclopentadienyliron)arene salt compounds, and pyridinium salts, and any combination thereof.

In another embodiment, the cation of the cationic photoinitiator is selected from the group consisting of aromatic diazonium salts, aromatic sulfonium salts, aromatic iodonium salts, metallocene based compounds, aromatic phosphonium salts, polymeric sulfonium salts, naphthyl-sulfonium salts, and any combination thereof. In an embodiment, the cationic photoinitiator is selected from the group consisting of triarylsulfonium salts, diaryliodonium salts, and metallocene based compounds, and any combination thereof.

In an embodiment, the cationic photoinitiator has an anion selected from the group consisting of BF₄⁻, AsF₆⁻, SbF₆⁻, PF₆⁻, [B(CF₃)₄]⁻, B(C₆F₅)₄⁻, B[C₆H₃-3,5(CF₃)₂]₄⁻, B(C₆H₄CF₃)₄⁻, B(C₆H₃F₂)₄⁻, B[C₆F₄-4(CF₃)]₄⁻, Ga(C₆F₅)₄⁻, [(C₆F₅)₃B—C₃H₃N₂—B(C₆F₅)₃]⁻, [(C₆F₅)₃B—NH₂—B(C₆F)₃]⁻, tetrakis(3,5-difluoro-4-alkyloxyphenyl)borate, tetrakis(2,3,5,6-tetrafluoro-4-alkyloxyphenyl) borate, perfluoroalkylsulfonates, tris[(perfluoroalkyl)sulfonyl]methides, bis[(perfluoroalkyl)sulfonyl]imides, perfluoroalkylphosphates, tris(perfluoroalkyl)trifluorophosphates, bis(perfluoroalkyl)tetrafluorophosphates, tris(pentafluoroethyl)trifluorophosphates, and (CH₆B₁₁Br₆)⁻, (CH₆B₁₁Cl₆)⁻ and other halogenated carborane anions.

In an embodiment, the cationic photoinitiator has a cation selected from the group consisting of aromatic sulfonium salts, aromatic iodonium salts, and metallocene based compounds with at least an anion selected from the group consisting of SbF₆⁻, PF₆⁻, B(C₆F₅)₄⁻, [B(CF₃)₄]⁻, tetrakis(3,5-difluoro-4-methoxyphenyl)borate, perfluoroalkylsulfonates, perfluoroalkylphosphates, tris[(perfluoroalkyl)sulfonyl]methides, and [(C₂F₅)₃PF₃]⁻.

Examples of cationic photoinitiators useful for curing at 300-475 nm without a sensitizer include 4-[4-(3-chlorobenzoyl)phenylthio]phenylbis(4-fluorophenyl)sulfonium hexafluoroantimonate, 4-[4-(3-chlorobenzoyl)phenylthio]phenylbis(4-fluorophenyl)sulfonium tetrakis(pentafluorophenyl)borate, 4-[4-(3-chlorobenzoyl)phenylthio]phenylbis(4-fluorophenyl)sulfonium tetrakis(3,5-difluoro-4-methyloxyphenyl)borate, 4-[4-(3-chlorobenzoyl)phenylthio]phenylbis(4-fluorophenyl)sulfonium tetrakis(2,3,5,6-tetrafluoro-4-methyloxyphenyl)borate, tris(4-(4-acetylphenyl)thiophenyl)sulfonium tetrakis(pentafluorophenyl)borate (Irgacure® PAG 290 from BASF), tris(4-(4-acetylphenyl)thiophenyl)sulfonium tris[(trifluoromethyl)sulfonyl]methide (Irgacure® GSID 26-1 from BASF), tris(4-(4-acetylphenyl)thiophenyl)sulfonium hexafluorophosphate (Irgacure® 270 from BASF), and HS-1 available from San-Apro Ltd.

Preferred cationic photoinitiators include, either alone or in a mixture: bis[4-diphenylsulfoniumphenyl]sulfide bishexafluoroantimonate; thiophenoxyphenylsulfonium hexafluoroantimonate (available as Chivacure 1176 from Chitec), tris(4-(4-acetylphenyl)thiophenyl)sulfonium tetrakis(pentafluorophenyl)borate (Irgacure® PAG 290 from BASF), tris(4-(4-acetylphenyl)thiophenyl)sulfonium tris[(trifluoromethyl)sulfonyl]methide (Irgacure® GSID 26-1 from BASF), and tris(4-(4-acetylphenyl)thiophenyl)sulfonium hexafluorophosphate (Irgacure® 270 from BASF), [4-(1-methylethyl)phenyl](4-methylphenyl) iodonium tetrakis(pentafluorophenyl)borate (available as Rhodorsil 2074 from Rhodia), 4-[4-(2-chlorobenzoyl)phenylthio]phenylbis(4-fluorophenyl)sulfonium hexafluoroantimonate (as SP-172 from Adeka), SP-300 from Adeka, and aromatic sulfonium salts with anions of (PF₆₋ₘ(CₙF₂ₙ₊₁)ₘ)⁻ where m is an integer from 1 to 5, and n is an integer from 1 to 4 (available as CPI-200K or CPI-200S, which are monovalent sulfonium salts from San-Apro Ltd., TK-1 available from San-Apro Ltd., or HS-1 available from San-Apro Ltd.).

The polymer forming part, the particle composition, or both can include any suitable amount of the cationic photoinitiator, for example, in certain embodiments, in an amount up to about 10% by weight, in embodiments, up to about 5% by weight, and in further embodiments from about 0.01% to about 5% by weight. In a further embodiment, the amount of cationic photoinitiator is present in an amount from about 0.1 wt % to about 4 wt %, and in other embodiments from about 0.1 wt % to about 3 wt %.

In addition to the polymer forming part and the swellable particles, the polymerizable composition comprises the following components in certain embodiments.

### Optional Solvent

The polymerizable composition may optionally comprise a solvent. The solvent may be a mixture of more than one solvent. Suitable solvents include alcohols, ketones, esters, or ethers; preferably an alcohol such as methanol, ethanol or iso-propanol. Water may also be a suitable solvent under certain circumstances. A solvent, preferably a non-aqueous solvent, may be present to facilitate penetration into the swellable particles of the compounds comprising a polymerizable group in the polymer forming part, for instance, if certain compounds comprising a polymerizable group in the polymer forming part have a molecular weight that is too high to penetrate the particles on their own. Compounds comprising a polymerizable group with a lower molecular weight are more likely to penetrate and swell the particles without the need of a non-aqueous solvent than compounds comprising a polymerizable group with a higher molecular weight. In certain embodiments, the polymerizable composition is substantially devoid of an aqueous solvent. In embodiments, the polymerizable composition comprises less than 5 wt % of water, based on the total weight of the polymerizable composition. In embodiments, the polymerizable composition comprises 50 wt % or less of solvent, based on the total weight of the polymerizable composition, such as 40 wt % or less, 30 wt % or less, 20 wt % or less, 10 wt % or less, or 5 wt % or less.

### Optional Filler

The polymerizable composition may comprise a filler. The definition of filler is meant to include any particles that do not fit under the definition of swellable particles, such as particles having a Tg that is too high or having a swelling ratio that is too low by mass from their non-swollen state when swollen to equilibrium in a mixture consisting of the polymer forming part and the particles. Examples of suitable fillers include both organic and inorganic fillers. The filler may possess a surface functionality or not. The filler may be micro or nano-particles comprising organic particles, such as core-shell particles, inorganic particles, pigments, or plasticizers. In an embodiment, the filler comprises an inorganic filler, such as SiO₂, AlO₂, TiO₂, ZnO₂, SnO₂, Am—SnO₂, ZrO₂, Sb—SnO₂, Al₂O₃, or carbon black. In an embodiment, the filler comprises an organic filler, such as polyurethane particles, polystyrene particles, poly(methyl methacrylate) particles, polycarbonate particles, core-shell particles, or any other particles formed using the components that may make up the particle composition but that do not attain the requisite Tg, 1/T₂, volume average cross-link density v, or swelling ratio to meet the claim limitations of the swellable particles.

In an embodiment, the filler is present in the polymerizable composition in an amount of greater than 0.01 wt %, 0.1 wt %, 0.5 wt %, or 1 wt %, based on the total dry weight (excluding solvents) of the polymerizable composition. In an embodiment, the filler is present in the polymerizable composition in an amount of less than 25 wt %, 20 wt %, 15 wt %, or 10 wt %, based on the total dry weight (excluding solvents) of the polymerizable composition. In an embodiment, the filler is present in an amount of from 0.01 wt % to 25 wt %, from 0.01 wt % to 20 wt %, from 0.1 wt % to 15 wt %, or from 1 wt % to 10 wt %, based on the total dry weight (excluding solvents) of the polymerizable composition.

### Other Optional Components

Additional components that may be present in the polymerizable composition include components that may be present in a form other than particles (i.e. that are not swellable particles or filler) such as stabilizers, such as viscosity stabilizers or light stabilizers, UV absorbers, dyes, plasticizers, surfactants, antioxidants, wetting agents, photosensitizers, chain transfer agents, and defoamers, flame retardants, silane coupling agents, acid scavengers, and/or bubble breakers.

### Applications

In accordance with an embodiment of the invention, an article or coating can be formed by polymerizing the polymerizable composition. Stress at break or maximum stress are measured according to ISO 34-2:2015. G₀ is measured according to ISO 37 (3^{rd} Edition 1994-05-15).

In an embodiment, an article comprises a multi-polymer network wherein at least one of the polymer networks comprise particles swollen to a swelling ratio of 300% or more by mass, wherein the article has a G₀ of 500 J/m² or more, a tensile modulus of 100 MPa or less, 50 MPa or less, or 30 MPa or less, and a stress at break or maximum stress that is greater that is than its tensile modulus. In an embodiment, an article comprises a multi-polymer network wherein at least one of the polymer networks comprise particles swollen to a swelling ratio of 300% or more by mass, wherein the article has a G₀ 500 J/m² or greater, a tensile modulus of 20 MPa or less, 15 MPa or less, 10 MPa or less, 7 MPa or less, or 5 MPa or less, and a stress at break or maximum stress that is greater than its tensile modulus.

In an embodiment, an article comprises a multi-polymer network wherein at least one of the polymer networks comprise particles swollen to a swelling ratio of 300% or more by mass, wherein the article has a G₀ of 500 J/m² or more, a tensile modulus of 100 MPa or less, 50 MPa or less, or 30 MPa or less, and 0.1 MPa or more, or 0.2 MPa or more, and a stress at break or maximum stress that is greater that is than its tensile modulus. In an embodiment, an article comprises a multi-polymer network wherein at least one of the polymer networks comprise particles swollen to a swelling ratio of 300% or more by mass, wherein the article has a G₀ 500 J/m² or greater, a tensile modulus of 20 MPa or less, 15 MPa or less, 10 MPa or less, 7 MPa or less, or 5 MPa or less, and 0.1 MPa or more, or 0.2 MPa or more, and a stress at break or maximum stress that is greater than its tensile modulus.

In an embodiment, an article comprises a multi-polymer network wherein at least one of the polymer networks comprise particles swollen to a swelling ratio of 250% or more by mass, wherein the article has a G₀ of 500 J/m² or more, a tensile modulus of 100 MPa or less, 50 MPa or less, or 30 MPa or less, and a stress at break or maximum stress that is greater that is than its tensile modulus. In an embodiment, an article comprises a multi-polymer network wherein at least one of the polymer networks comprise particles swollen to a swelling ratio of 250% or more by mass, wherein the article has a G₀ 500 J/m² or greater, a tensile modulus of 20 MPa or less, 15 MPa or less, 10 MPa or less, 7 MPa or less, or 5 MPa or less, and a stress at break or maximum stress that is greater than its tensile modulus.

In an embodiment, an article comprises a multi-polymer network wherein at least one of the polymer networks comprise particles swollen to a swelling ratio of 250% or more by mass, wherein the article has a G₀ of 500 J/m² or more, a tensile modulus of 100 MPa or less, 50 MPa or less, or 30 MPa or less, and 0.1 MPa or more, or 0.2 MPa or more, and a stress at break or maximum stress that is greater that is than its tensile modulus. In an embodiment, an article comprises a multi-polymer network wherein at least one of the polymer networks comprise particles swollen to a swelling ratio of 250% or more by mass, wherein the article has a G₀ 500 J/m² or greater, a tensile modulus of 20 MPa or less, 15 MPa or less, 10 MPa or less, 7 MPa or less, or 5 MPa or less, and 0.1 MPa or more, or 0.2 MPa or more, and a stress at break or maximum stress that is greater than its tensile modulus.

In an embodiment, an article can be formed by first introducing the polymerizable composition into a mold or coating the polymerizable composition on a surface. Optionally, the solvent, if present, is substantially evaporated such as by applying heat or merely waiting for substantial evaporation to take place. The polymerizable composition is then polymerized, thereby forming the article or coating.

In an embodiment, the method further comprises the steps of swelling the formed article or coating with a second polymerizable composition and polymerizing the second polymerizable composition. The second polymerizable composition may be the same as or different from the first polymerizable composition (i.e. the polymerizable composition comprising the polymer forming part and swellable particles). In an embodiment, the second polymerizable composition swells the formed article or coating by 50% or more by mass of the formed article or coating, 100% or more by mass, 200% or more by mass, 300% or more by mass, or 400% or more by mass. After polymerizing the second polymerizable composition, the article or coating may then be referred to as a third order multi-network polymer. This step may be repeated additional times, thereby forming fourth or higher order multi-network polymers.

Polymerization may be initiated by any suitable way, depending on the necessary initiation mechanism for the components chosen for the polymer forming part. In an embodiment, polymerization is initiated via irradiation of the polymerizable composition with light or heat. In an embodiment, the polymerization is initiated via a reduction oxidation mechanism. Preferably, the polymerizable composition is polymerized by applying UV light. The radiation may be provided by a lamp, laser, LED, or other light sources.

Further applications of the invention include additive fabrication processes. Additive fabrication processes, sometimes known as three-dimensional printing, utilize computer-aided design (CAD) data of an object to build three-dimensional objects. These three-dimensional objects may be formed from liquid resins, powders, or other materials. The CAD data is loaded into a computer that controls a machine that forms and binds layers of materials into desired shapes. The desired shapes correspond to portions of a three-dimensional object, such as individual cross-sections of the three-dimensional object. The desired shapes may be formed by selectively dispensing the material into the desired shape and then curing or melting the material if necessary, such as in an inkjet printing system. Another way of forming the desired shapes is by selectively curing or melting the material into the desired shape out of a large bed or vat of material, such as in stereolithography, selective laser sintering, or the HP Multi Jet Fusion™ techniques.

In an embodiment, a method of forming a three-dimensional object comprises the steps of forming a layer of the polymerizable composition, curing the layer with radiation to form a desired shape, and repeating the steps of forming and curing a layer of the polymerizable composition a plurality of times to obtain a three-dimensional object. In an embodiment, a method of forming a three-dimensional object comprises the steps of selectively dispensing a layer of the polymerizable composition, curing the layer with radiation to form a desired shape, and repeating the steps of selectively dispensing and curing a layer of the polymerizable composition a plurality of times to obtain a three-dimensional object. In an embodiment, a method of forming a three-dimensional object comprises the steps of forming a layer of the polymerizable composition, selectively curing the layer with radiation to form a desired shape, and repeating the steps of forming and selectively curing a layer of the polymerizable composition a plurality of times to obtain a three-dimensional object.

Some potential applications of articles disclosed herein include as molded articles, shoe soles, eyeglasses, three-dimensional objects formed by additive fabrication processes, coatings for optical fibers, medical devices or coatings on medical devices, other coatings, and paints.

In an embodiment, a composition is formed comprising particles that are themselves multi-network polymers, so called multi-network particles. For example, multi-network particles may be formed by the following process. A first polymer network is formed having a volume average cross-link density (v) at 100° C. of from 0.01 to 10 mol/l, from 0.025 to 10 mol/l, from 0.05 g/mol to 10 mol/l, from 0.1 to 10 mol/l, from 0.2 to 10 mol/l, from 0.275 to 10 mol/l, from 0.5 to 10 mol/l, from 0.75 to 10 mol/l, or from 1.0 to 10 mol/l, from 0.01 to 5.5 mol/l, from 0.025 to 5.5 mol/l, from 0.05 g/mol to 5.5 mol/l, from 0.1 to 5.5 mol/l, from 0.2 to 5.5 mol/l, from 0.275 to 5.5 mol/l, from 0.5 to 5.5 mol/l, from 0.75 to 5.5 mol/l, or from 1.0 to 5.5 mol/l, as measured by DMTA. The first polymer network may be formed by polymerizing a first liquid composition comprising components that may form the polymer forming part as described above. Second, the first polymer network is swollen in a second liquid composition such that the first polymer network swells to a swelling ratio of 50% or more, 100% or more, 150% or more, 200% or more, 300% or more, 325% or more, 350% or more, 375% or more, 400% or more, or 425% or more by mass from the first polymer network's non-swollen state. The liquid composition is polymerized, thereby forming a double-network polymer. The process may be repeated by swelling the double-network polymer in an additional liquid composition and polymerizing the additional liquid composition. The resulting multi-polymer network is then formed into multi-network particles by, for example, milling or grinding. The multi-network particles are then dispersed in a polymer forming part as previously described, thereby forming a multi-network particle composition. The multi-network particle composition may then be formed into an article or coating.

The multi-network particles thus comprise two or more interpenetrating polymer networks, wherein the chains In an embodiment, the multi-network particles have a Tg of less than 25° C., as determined by DMTA by first drying the multi-network particles in air until they form a film and then drying the film for 16 hours in a vacuum oven at 80° C.

Accordingly, in an embodiment a polymerizable composition comprises
a. a polymer forming part comprising
   i. one or more compounds comprising a polymerizable group, and
   ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 0.2 mol/l or less,
b. multi-network particles in an amount of 5 to 35 wt %, based on the total amount of the multi-network particles and the polymer forming part in the polymerizable composition, the multi-network particles comprising cross-links and being formed from a process comprising the steps of:
   i. swelling a first polymer network having a volume average cross-link density (v) at 100° C. of from 0.01 to 10 mol/l as measured by DMTA, in a second network composition, the second network composition comprising
      1. one or more compounds comprising a polymerizable group, and
      2. optionally, an initiator,
   wherein a composition consisting of the second network composition, if 90% or more of the polymerizable groups in the second network composition are polymerized, has a Tg as determined by DMTA of less than 25° C. and a volume average cross-link density at 100° C. as determined by DMTA of 0.2 mol/l or less, and
   ii. polymerizing the second network composition, thereby forming a multi-network polymer,
wherein the first polymer network swells to a swelling ratio of 50% or more by mass from its non-swollen state if the first polymer network is swollen to equilibrium in the second network composition.

The following Examples may further illustrate the invention, but are not to be construed as limiting its scope in any way.

### EXAMPLES

In the following Examples, the abbreviation n.t. is used for items that are “not tested” or are otherwise unknown.

### Materials Used in Examples

Table 0.1 lists certain raw materials used in these Examples. The terms “cross-linker” and “photoinitiator” are used in the examples to mean 1,4-butanediol diacrylate and 2-hydroxy-2-methyl-1-phenyl-propan-1-one, respectively.

TABLE 0.1
Raw Materials

| | | Density | Mol. | | | |
|---|---|---|---|---|---|---|
| | | at 25° C. | Wt. | Purity | | |
| Compound | Type | (g/mL) | (g/mol) | (%) | Origin | CAS # |
| Ethyl acrylate (EA) | Monomer | 0.918 | 100.12 | 99 | Sigma Aldrich | 140-88-5 |
| Butyl Acrylate (BA) | Monomer | 0894 | 128.17 | >99 | Sigma Aldrich | 141-32-2 |
| Ethyl Hexyl Acrylate (EHA) | Monomer | 0.885 | 184.28 | 98 | Sigma Aldrich | 103-11-7 |
| Isodecyl Acrylate (IDA) | Monomer | 0.875 | 212.33 | 99 | Sigma Aldrich | 1330-61-6 |
| [[(butylamino)carbonyl] oxy]ethyl | Monomer | — | 215 | — | Rahn | 63225-53-6 |
| acrylate (BACOEA) | | | | | | |
| Methyl methacrylate (MMA) | Monomer | 0.936 | 100.12 | — | — | 80-62-6 |
| 1,4-Butanediol Diacrylate (BDA) | Cross-linker | 1.051 | 198.22 | 90 | Sigma Aldrich | 1070-70-8 |
| 2-Hydroxy-2-methyl-1-phenyl- | Photoinitiator | n.t. | 164.2 | >95 | BASF | 7473-98-5 |
| propan-1-one (Darocur ® 1173) | | | | | | |

BACOEA is commercially available as GENOMER 1122.

### Particles Synthesis

To a four-neck 2 L glass reactor equipped with a stirrer, N₂ inlet, thermocouple, cooler and feedtank, 379.3 g demineralized water and 0.25 g potassium persulfate was added. The reactor content was heated to 85° C. In a feedtank an emulsified monomer feed was made by mixing 440.1 g demineralized water, sodium lauryl sulfate (SLS), monomer (ethyl acrylate (EA) or butyl acrylate (BA)), and butanediol diacrylate (BDA) under stirring. The amount of SLS, monomer, and BDA is shown in Table 0.2. In a separate feed vessel an initiator feed was prepared by dissolving 2.2 g potassium persulfate in 43.3 g demineralized water. While keeping the reactor at 85° C., the monomer feed and initiator feed were simultaneously fed into the reactor over 120 minutes. After completion of both feeds the reactor was kept at 85° C. for another 60 minutes. Next, a slurry of 0.7 g tert-butylhydroperoxide (70 wt % in water) in 2.2 g demineralized water is formed. 50% of the slurry of tert-butylhydroperoxide in demineralized water is then added to the reactor. A solution of 0.8 g iso-ascorbic acid in 16.2 g demineralized water was fed in to the reactor over 60 minutes. Halfway through this feed, the remaining 50% of the slurry of tert-butylhydroperoxide in demineralized water was added. Finally, the reaction mixture was cooled to ambient temperature and the pH was adjusted to pH 7.5-8.5 by slowly adding a 25 wt % ammonia solution. The polymer dispersion was preserved by adding 4.2 g Proxel Ultra 10 (9.25 wt % 1,2-benzisothiazol-3(2H)-one, 4.9 wt % potassium hydroxide, and 88.85 wt % water). The solid content was adjusted to 30 wt % in demineralized water. The batch was filtered through 50 μm filter cloth.

To change the particle size the amount of sodium lauryl sulfate was adjusted. To change the cross-link density the ratio of butanediol diacrylate to monomer was adjusted.

Table 0.2 lists the particles that were obtained.

TABLE 0.2
Particles Obtained

| | | | | wt % SLS | |
|---|---|---|---|---|---|
| | | | | (based on | |
| | | Particle | Amount | total of | |
| Particle | | Size | BDA | monomer | BDA:monomer |
| Sample | Monomer | (nm) | (% mol) | and BDA) | (wt ratio) |
| 3A | EA | 175 | 0.7% | 1.2 | 1.4:98.6 |
| 3B | EA | 179 | 2.8% | 1.2 | 5.3:94.7 |
| 4A | EA | 284 | 0.7% | 0.8 | 1.4:98.6 |
| 4B | EA | 308 | 2.8% | 0.8 | 5.3:94.7 |
| 9A | EA | 194 | 5.3% | 1.2 | 10:90 |
| 9B | EA | 355 | 5.3% | 0.8 | 10:90 |
| 10A | EA | 177 | 8.2% | 1.4 | 15:85 |
| 10B | EA | 347 | 8.2% | 0.9 | 15:85 |
| 28 | BA | 212 | 8% | unknown | 11:89 |
| 012 | MMA | 194 | 5.3% | — | 10:90 |

### Polymer Forming Part Synthesis and Property Measurement

Polymer forming parts were formed as separate compositions by mixing together and stirring the various components. The Tg (° C.) and the volume average cross-link density are determined by DMTA.

Particle 1/T₂ by ¹H NMR T₂ Relaxometry

It was found that the particle volume average cross-link density corresponds with a relaxation rate 1/T₂, as determined by ¹H NMR T₂ relaxometry using a Hahn-echo pulse sequence (HEPS) at 110° C., where T₂ is defined as the time at which the signal amplitude has decayed to 1/e (approximately 36.8%) of its original value. A linear interpolation between data points is performed to determine when the required decay has been reached. 1/T₂ is measured using a low-field NMR spectrometer Minispec MQ20 operating at a proton resonance frequency of 20 MHz. Duration of 900 and 180° pulses is 2.8 and 5.2 μs, respectively. The dead time of the receiver is 7 μs. Dwell time of analog-to-digital converter (ADC) is 0.5 μs. Temperature regulation was performed using BVT3000 temperature unit with accuracy of ±1° C.

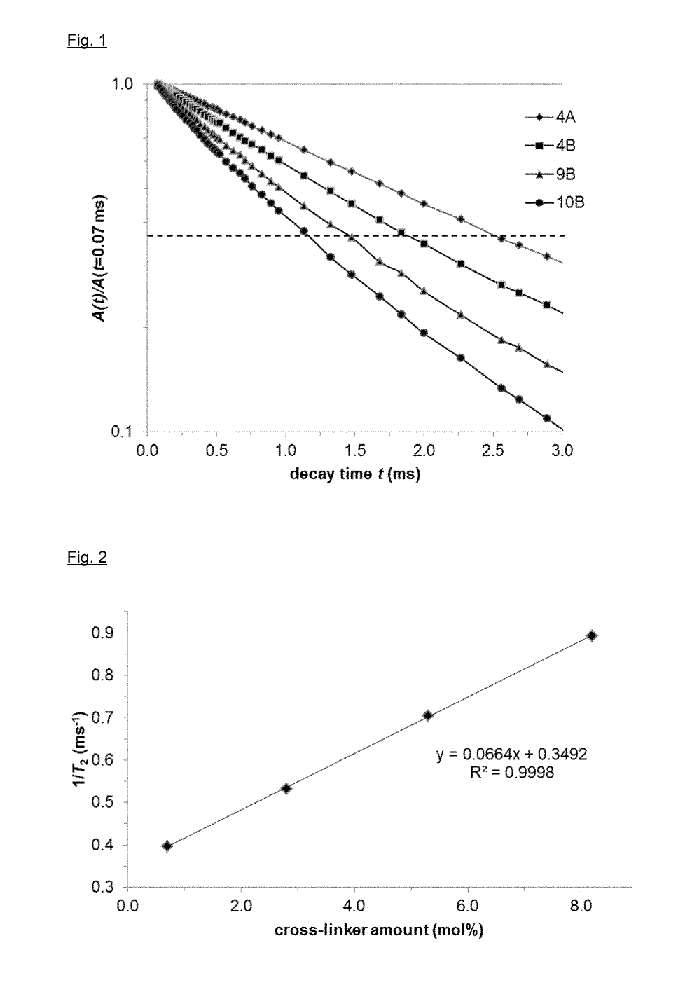

To verify correspondence of 1/T₂ and particle volume average cross-link density, by ¹H NMR T₂ relaxometry using a Hahn-echo pulse sequence (HEPS) at 110° C. is performed on Particle Samples, 4A, 4B, 9B, and 10B. The particles are tested dry, i.e. without any solvent, including water, present. T₂ is the time at which the signal amplitude has decayed to 1/e (approximately 36.8%) of its original value. The measured decay curves for each latex are plotted in FIG. 1.

Additionally, the theoretical volume average cross-link density is determined as follows according to equation (2) and equation (3) and using a density of 1100 g/l. First, the molecular weight between cross-links (Mc) of the particles is estimated according to the following equation (2)

$${M}_{c} = \frac{{MW}_{x} ( 1 - {w}_{x} )}{2 {w}_{x}} \qquad ( 2 )$$

wherein Mc is the molecular weight between cross-links in g/mol, MWₓ is the molecular weight of the cross-linker, and w, is the weight percent of the cross-linker in the particle composition. The volume average cross-link density (v) in mol/l is determined by the following equation (3):

$$v = \frac{ρ}{{M}_{c}} \qquad ( 3 )$$

wherein ρ is the density in g/l. The density is assumed to be 1100 g/l for all samples. Density may be measured using a pyknometer. The results are presented in Table 0.3.

TABLE 0.3
Particle Volume Average Cross-link Density

| | Cross-linker | | Theoretical volume average |
|---|---|---|---|
| Particle | amount | 1/T₂ | cross-link density |
| Sample | (mol %) | (ms⁻¹) | (mol/l) |
| 4A | 0.7 | 0.397 | 0.15 |
| 4B | 2.8 | 0.532 | 0.63 |
| 9B | 5.3 | 0.704 | 1.23 |
| 10B | 8.2 | 0.893 | 1.96 |

The mol % of cross-linker, and thereby the theoretical volume average cross-link density, shows excellent correspondence to 1/T₂, as shown in FIG. 2, as indicated by a R² value of greater than 0.99.

### Particle Size Measurement

The particles average size is measured using photon correlation spectroscopy (PCS) in accordance with IS013321:1996 on a Malvern Zetasizer Nano S90 machine. Water is used as the dispersant (viscosity at 25° C. of 0.8872 cPs, refractive index of 1.330) with the dispersant viscosity used as the sample viscosity, the temperature is set to 25° C., and the equilibration time is set to 120 seconds.

### Swelling Ratio Measurement

A small sample of particles are dried into a film, weighed (m₁), and placed in a small aluminum cup of known weight. An amount of polymer forming part sufficient to cover the sample of particles is added to the aluminum cup. The sample is allowed to swell to equilibrium over 48 hours. The excess of polymer forming part is then carefully removed and the remaining swollen particles are weighed (m₂). Depending on the size of the swollen particles, a sieve, a syringe fitted with a filter, or merely a pipette may be used to remove substantially all excess of the polymer forming part. The swelling ratio is determined by the following equation: % swelling=(m₂−m₁)/m₁.

### Casting Plate Assembly

A casting plate was prepared from two glass plates 10.5×15 cm. A 2 mm thick EPDM foil is cut to the shape of the bottom glass plate and secured using double sided adhesive tape (Tesa® 4964). The EPDM foil is cut to leave only 1 cm of foil along the rim of the bottom glass plate to form a gasket on the bottom glass plate. The top glass plate and the bottom glass plate (including gasket) are treated with Frekote NC-55 release agent, heated in an oven at 80° C. for 4 minutes, and then treated again with Frekote NC-55 release agent. Krytox LVP grease is then applied on the surface of the gasket so that a continuous seal is formed after clamping the casting plate. A 18 G needle is placed on one side of the gasket to provide for injection of a polymerizable composition. A 27 G needle is placed on the opposite side of the gasket to allow for venting of air. The casting is clamped with 15 mm foldback clips (Staples).

### Sample Polymerizable Composition Preparation

If the sample contains particles, dry particles are cut and weighed and placed in a flask with a stirrer. A mixture of the monomer, photoinitiator, and cross-linker (i.e. the polymer forming part) are then added into the same flask (or to an empty flask if no particles are present). This polymerizable composition is allowed to mix sufficiently and any particles allowed to swell to equilibrium.

### Cured Film Formation

The polymerizable composition is injected into the casting through the 18 G needle using a 50 ml syringe until the casting is filled with polymerizable composition.

The polymerizable composition is polymerized via a Vilber Lourmat VL-215.L UV lamp (intensity 2.3 mW/cm² at 15 cm distance). For polymerizable compositions containing ethyl acrylate or butyl acrylate, the curing time was 2.5 hours. For polymerizable compositions containing ethyl hexyl acrylate or isodecyl acrylate, the curing time was 24 hours.

After curing, the clamped casting plate assembly is placed in an aluminum tray and covered with dry ice. After cooling for several minutes, the glass plates are separated and the cured film removed.

The cured films are placed in a vacuum oven for at least two days at 80° C. (90° C. for the butyl acrylate containing formulations), in order to remove any residual uncured monomer.

The cured films were cut into the necessary specimen size. From 3 to 5 specimens are used for each test. The values for E, E′, Tg, and G₀ reported are averages of the tested samples.

### DMTA Tests

The storage modulus (E′), loss modulus (E″) and the tangent delta (tan δ) as a function of temperature are determined by DMTA as follows. The samples for the measurement are punched out of a cured film. The thickness is measured with a calibrated Heidenhain thickness meter. Typical sample size is a width of 2 mm, length between clamps of 25 mm, and a thickness varying between 1 and 2 mm. The dynamic mechanical measurements are performed in accordance with ASTM D5026 on equipment of the firm TA called RSA-G2 (Rheometrics Solids Analyser G2) at a frequency of 1 Hz and over a temperature area of −100° C. tot 150° C. with a heating speed of 5° C./min. The following deviations from ASTM D5026 are permitted: allowed temperature deviation±2° C. (in standard±1° C.), allowed force deviation±2% (in norm standard±1%), allowed frequency deviation±2% (in standard±1%), and heating speed 5° C./min (in standard 1 to 2° C./min).

To test Tg of particles, the particles are first dried in air until they form a film. After forming a film, the film is further dried overnight in a vacuum oven at 80° C. The Tg is determined as the temperature at which the loss modulus E″ at a frequency of 1 Hz is at its maximum value, as measured using DMTA.

A density of 1.1 kg/I is assumed for each polymer forming part.

### Tensile Tests

Tensile properties are measured according to the international standard ISO 37 (3^{rd} Edition 1994-05-15) “Rubber, vulcanized or thermoplastic—Determination of tensile stress-strain properties” on a Zwick digital tensile machine type Z010. The parameters of the tensile test are shown in Table 0.4.

TABLE 0.4
Tensile Test Machine Parameters

| Force cell | 200N | |
|---|---|---|
| Extensometer | VideoXtens | |
| Lens | 12 | mm |
| Test Specimen | ISO 37 type 3 | |
| Grip Length | 30 | mm |
| Gauge Length | ±15 | mm |
| E-modulus Test Speed | 50 | mm/min |
| Test Speed | 50 | mm/min |

The tensile modulus E is determined as follows. A first strain is the strain at the point where the stress of the sample is 0.004 MPa more than the stress measured at zero strain. A second strain is the strain at the first strain plus 0.1 (10% additional strain). The tensile modulus E is the slope of the linear least-squares regression line for all stress data points between these two strains.

E is determined by averaging the results across the samples tested. The tensile curves shown in the figures are the one curve from each set of samples that is most representative of the 3-5 samples tested. The curve was preferentially selected to be from a sample that broke in the thin portion of the dog bone shape (i.e. did not break at the clamps), and did not slip from the clamps (which would have resulted in not breaking at all).

### Tear Test

The tear strength properties are measured according to the international standard ISO 34-2:2015. “Rubber, vulcanized or thermoplastic—Determination of tear strength—Part 2: Small (Delft) test pieces” on a Zwick digital tensile machine type Z010. Sample length is 60 mm, width is 9.3 mm, slit width (initial crack length) is 5 mm, and thickness is ˜1.9 mm. The parameters of the tear test are shown in Table 0.5.

TABLE 0.5
Tear Test Machine Parameters

| Force cell | 200N | |
|---|---|---|
| Extensometer | Machine displacement | |
| Test Specimen | ISO 816 | |
| Grip Length (L₀) | 30 | mm |
| Test Speed | 6 | mm/min |

G₀ is calculated according to the following equation (4).

$${G}_{0} = \frac{1}{E} \times {( C \times σ c \sqrt{π \frac{a}{1000}} )}^{2} \times {10}^{6} [ J \cdot {m}^{- 2} ] \qquad ( 4 )$$

G₀ is the critical energy release rate in J/m², E is the tensile modulus in MPa as determined in the tensile test, ac is the maximum stress in MPa as determined from the tear test, and a is half the initial crack length in mm (2.5 mm in the tear test). C is a constant which is calculated according to the following equation (5):

$$C = \sqrt{\frac{1}{cos \frac{π \cdot a}{w}}} \qquad ( 5 )$$

wherein a is half the initial crack length in mm (2.5 mm in the tear test), and w is the width of the sample in mm (9.3 mm in the tear test).

### Hysteresis Test

Dog bone shaped samples of 20 mm in length are placed in the same apparatus as used in the tensile test. The test speed is 100 μm/s and the test is conducted at 20° C. The sample is first elongated to a set maximum extension ratio value (λₘₐₓ=λ₁) and then relaxed to a strain of zero (λ=1). The sample is extended to λₘₐₓ and relaxed twice more (for a total of three times at the first Aₘₐₓ). The value for λₘₐₓ is then increased (λₘₐₓ=λ₂) and three extension/relaxation cycles are carried out at this new λₘₐₓ. This process is repeated several times.

### Example 1—Comparison of Single Network and Double Network Properties

Two films were formed: a single network (Ex1-1-SN) and a double network (Ex 1-2-DN) according to the above described procedure. The single network polymerizable composition and the double network polymerizable composition differ in that 12 wt % of swellable particles are added into the double network polymerizable composition. The polymerizable compositions are shown in Table 1.1.

TABLE 1.1
Example 1 Polymerizable Compositions

| | | | | | Photoinitiator |
|---|---|---|---|---|---|
| | Particle | Particles | EA | BDA | amount |
| Sample | Type | (wt %) | (wt %) | (wt %) | (wt %) |
| Ex1-1 SN | — | — | 99.96 | 0.020 | 0.016 |
| Ex1-2 DN | 9B | 12 | 87.97 | 0.017 | 0.014 |

The cured films were subjected to a tear test and a tensile test. Results of the tensile test are shown in FIG. 3. FIG. 3 shows that Ex1-2-DN achieves earlier strain hardening and a substantially higher stress at break than Ex1-1-SN while remaining soft (similar initial slope). The modulus and fracture toughness of each sample is given in Table 1.2, below:

TABLE 1.2
Example 1 Modulus and Fracture Toughness

| | E | Fracture Toughness G₀ |
|---|---|---|
| Sample | (MPa) | (J/m²) |
| Ex1-1 SN | 0.66 | 719 |
| Ex1-2 DN | 0.65 | 1420 |

The modulus of Ex1A-2 DN is similar to that of Ex1A-1 SN. The double network demonstrates a large increase in fracture toughness over the single network. The double network is substantially stronger than the single network, as shown by substantially higher stress at break and maximum stress, and tougher, as shown by the double network's substantially higher fracture toughness.

### Example 2—Further Comparison of Single Network and Double Network Properties

Four different polymer forming parts are formed according to the above procedure. Four polymer forming parts have 0.2 wt % of cross-linker, whereas the other four polymer forming parts have 0.02 wt % of cross-linker, thereby reduces the volume average cross-link density of a film formed from the polymer forming part. The polymer forming part compositions, their Tg, and their volume average cross-link density once 90% or more polymerized, are as shown in Table 2.1, below. The films for polymer forming part compositions comprising 0.02 wt % of BDA (Ex2-9 & 2-13 PFP, Ex2-10 & 2-114 PFP, Ex2-11 & 2-115 PFP, and Ex2-12 & 2-16 PFP) were additionally subjected to the tensile test and the tear test, and the results presented in Table 2.3 and Table 2.4.

TABLE 2.1
Example 2 Polymer forming part Compositions

| | | | | Photo- | | | |
|---|---|---|---|---|---|---|---|
| | | | | initiator | | | |
| | | Monomer | BDA | amount | Tg | E′ (100° C.) | v (100° C.) |
| Sample | Monomer | (wt %) | (wt %) | (wt %) | (° C.) | (MPa) | (mol/l) |
| Ex2-1 | EA | 99.78 | 0.2 | 0.016 | −15 | 0.87 | 0.0931 |
| & Ex2- | | | | | | | |
| 5 PFP | | | | | | | |
| Ex2-2 | BA | 99.78 | 0.2 | 0.016 | −47 | 0.57 | 0.0587 |
| & Ex2- | | | | | | | |
| 6 PFP | | | | | | | |
| Ex2-3 | EHA | 99.78 | 0.2 | 0.016 | −58 | 0.23 | 0.0249 |
| & Ex2- | | | | | | | |
| 7 PFP | | | | | | | |
| Ex2-4 | IDA | 99.78 | 0.2 | 0.016 | −70 | 0.31 | 0.0331 |
| & Ex2- | | | | | | | |
| 8 PFP | | | | | | | |
| Ex2-9 | EA | 99.96 | 0.02 | 0.02 | −16 | 0.56 | 0.0596 |
| & Ex2- | | | | | | | |
| 13 PFP | | | | | | | |
| Ex2-10 | BA | 99.96 | 0.02 | 0.02 | −47 | 0.29 | 0.0306 |
| & Ex2- | | | | | | | |
| 14 PFP | | | | | | | |
| Ex2-11 | EHA | 99.96 | 0.02 | 0.02 | −69 | 0.13 | 0.0136 |
| & Ex2- | | | | | | | |
| 15 PFP | | | | | | | |
| Ex2-12 | IDA | 99.96 | 0.02 | 0.02 | −59 | 0.09 | 0.0093 |
| & Ex2- | | | | | | | |
| 16 PFP | | | | | | | |

To these polymer forming parts 14 wt % of particles (either 9B or 10B) were added to yield the polymerizable compositions shown in Table 2.2. The accuracy of the reported swelling ratio is +/−50%.

TABLE 2.2
Example 2 Polymerizable Compositions

| | | | | PFP | | | |
|---|---|---|---|---|---|---|---|
| | | | | Photo- | | | |
| | | PFP | PFP | initiator | | | |
| | PFP | Monomer | BDA | amount | Particle | Particle | Swelling |
| Sample | Monomer | (wt %) | (wt %) | (wt %) | Type | (wt %) | Ratio |
| Ex2-1 | EA | 85.81 | 0.17 | 0.014 | 9B | 14 | 527% |
| Ex2-2 | BA | 85.81 | 0.17 | 0.014 | 9B | 14 | 434% |
| Ex2-3 | EHA | 85.81 | 0.17 | 0.014 | 9B | 14 | 275% |
| Ex2-4 | IDA | 85.81 | 0.17 | 0.014 | 9B | 14 | 180% |
| Ex2-5 | EA | 85.81 | 0.17 | 0.014 | 10B | 14 | 480% |
| Ex2-6 | BA | 85.81 | 0.17 | 0.014 | 10B | 14 | 350% |
| Ex2-7 | EHA | 85.81 | 0.17 | 0.014 | 10B | 14 | 231% |
| Ex2-8 | IDA | 85.81 | 0.17 | 0.014 | 10B | 14 | 161% |
| Ex2-9 | EA | 85.97 | 0.017 | 0.017 | 9B | 14 | 527% |
| Ex2-10 | BA | 85.97 | 0.017 | 0.017 | 9B | 14 | 434% |
| Ex2-11 | EHA | 85.97 | 0.017 | 0.017 | 9B | 14 | 275% |
| Ex2-12 | IDA | 85.97 | 0.017 | 0.017 | 9B | 14 | 180% |
| Ex2-13 | EA | 85.97 | 0.017 | 0.017 | 10B | 14 | 480% |
| Ex2-14 | BA | 85.97 | 0.017 | 0.017 | 10B | 14 | 350% |
| Ex2-15 | EHA | 85.97 | 0.017 | 0.017 | 10B | 14 | 231% |
| Ex2-16 | IDA | 85.97 | 0.017 | 0.017 | 10B | 14 | 161% |

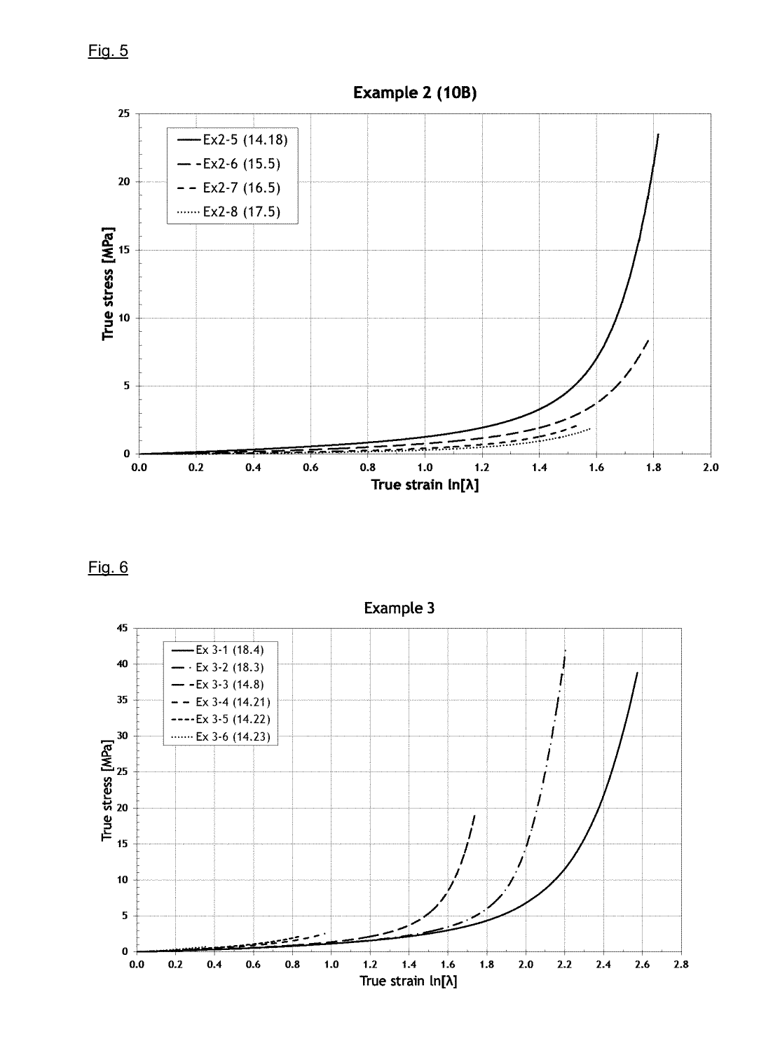

These polymerizable compositions were cured into films and subjected to the tensile test and the tear test. The results of the tensile test are shown in FIG. 4 for samples Ex2-1 through Ex2-4, and in FIG. 5 for samples Ex2-5 through Ex2-8. The results of the tensile test are tabulated for Ex2-9 through 2-16 in Table 2.3, below, and presented along with the tensile test data for the polymer forming part compositions comprising 0.02 wt % of BDA (Ex2-9 & 2-13 PFP, Ex2-10 & 2-14 PFP, Ex2-11 & 2-15 PFP, and Ex2-12 & 2-16 PFP).

TABLE 2.3
Tensile Test data for Ex 2-9 through 2-16 and Associated Polymer Forming Parts

| | | | | | | Tensile | Factor |
|---|---|---|---|---|---|---|---|
| | | | | | Factor | Strength | increase |
| | | | Particle | Tensile | increase | (max | over |
| | PFP | Particle | Amount | Modulus | over PFP | stress, | PFP |
| Sample | Monomer | Type | (wt %) | (MPa) | alone | MPa) | alone |
| Ex2-9 & | EA | — | 0 | 0.542 | N/A | 1.33 | N/A |
| Ex2-13 | | | | | | | |
| PFP | | | | | | | |
| Ex2-10 | BA | — | 0 | 0.255 | N/A | 0.78 | N/A |
| & Ex2- | | | | | | | |
| 14 PFP | | | | | | | |
| Ex2-11 | EHA | — | 0 | 0.058 | N/A | 0.21 | N/A |
| & Ex2- | | | | | | | |
| 15 PFP | | | | | | | |
| Ex2-12 | IDA | — | 0 | 0.041 | N/A | 0.25 | N/A |
| & Ex2- | | | | | | | |
| 16 PFP | | | | | | | |
| Ex2-9 | EA | 9B | 14 | 0.641 | 1.18 | 3.59 | 2.69 |
| Ex2-10 | BA | 9B | 14 | 0.289 | 1.13 | 1.05 | 1.34 |
| Ex2-11 | EHA | 9B | 14 | 0.118 | 2.03 | 0.66 | 3.20 |
| Ex2-12 | IDA | 9B | 14 | 0.058 | 1.41 | 0.54 | 2.13 |
| Ex2-13 | EA | 10B | 14 | 0.647 | 1.19 | 4.22 | 3.17 |
| Ex2-14 | BA | 10B | 14 | 0.294 | 1.15 | 1.63 | 2.08 |
| Ex2-15 | EHA | 10B | 14 | 0.036 | 0.62 | 0.67 | 3.26 |
| Ex2-16 | IDA | 10B | 14 | 0.066 | 1.61 | 0.57 | 2.23 |

The results of the tear test are shown in Table 2.4, below. Films with a tensile modulus lower than 0.1 MPa were observed to be tacky and the tear test data unreliable. Therefore, no tear test data is reported if the film had a tensile modulus lower than 0.1 MPa. Such samples are identified with a * in Table 2.4.

TABLE 2.4
Example 2 Fracture Toughness

| | PFP | | | | | Factor |
|---|---|---|---|---|---|---|
| | Mono- | | Particle | | | increase |
| | mer | Particle | Amount | Swelling | G₀ | over PFP |
| Sample | type | Type | (wt %) | Ratio | (J/m²) | alone |
| Ex2-1 | EA | 9B | 14 | 527% | 1631 | n.t. |
| Ex2-2 | BA | 9B | 14 | 434% | 602 | n.t. |
| Ex2-3 | EHA | 9B | 14 | 275% | 258 | n.t. |
| Ex2-4 | IDA | 9B | 14 | 180% | 332 | n.t. |
| Ex2-5 | EA | 10B | 14 | 480% | 1325 | n.t. |
| Ex2-6 | BA | 10B | 14 | 350% | 620 | n.t. |
| Ex2-7 | EHA | 10B | 14 | 231% | 380 | n.t. |
| Ex2-8 | IDA | 10B | 14 | 161% | 369 | n.t. |
| Ex2-9 & | EA | — | 0 | N/A | 875 | N/A |
| Ex2-13 | | | | | | |
| PFP | | | | | | |
| Ex2-10 | BA | — | 0 | N/A | 427 | N/A |
| & Ex2- | | | | | | |
| 14 PFP | | | | | | |
| Ex2-11 | EHA | — | 0 | N/A | * | N/A |
| & Ex2- | | | | | | |
| 15 PFP | | | | | | |
| Ex2-12 | IDA | — | 0 | N/A | * | N/A |
| & Ex2- | | | | | | |
| 16 PFP | | | | | | |
| Ex2-9 | EA | 9B | 14 | 527% | 1618 | 1.85 |
| Ex2-10 | BA | 9B | 14 | 434% | 834 | 1.95 |
| Ex2-11 | EHA | 9B | 14 | 275% | 517 | * |
| Ex2-12 | IDA | 9B | 14 | 180% | * | * |
| Ex2-13 | EA | 10B | 14 | 480% | 2784 | 3.18 |
| Ex2-14 | BA | 10B | 14 | 350% | 865 | 2.03 |
| Ex2-15 | EHA | 10B | 14 | 231% | * | * |
| Ex2-16 | IDA | 10B | 14 | 161% | * | * |

### Example 3—Influence of Volume Average Cross-Link Density of the Polymer Forming Part on Double Network Properties

Three polymer forming parts are formed according to the above procedure. The polymer forming part compositions, and their Tg and volume average cross-link density once 90% or more of the polymerizable groups are polymerized, are as shown in Table 3.1, below. Volume average cross-link density (v) is determined via DMTA.

TABLE 3.1
Example 3 Polymer forming part Compositions

| | | | | Photo- | | E′ | v |
|---|---|---|---|---|---|---|---|
| | Monomer | Monomer | BDA | initiator | Tg | (100° C.) | (100° C.) |
| Sample | Type | (mol %) | (mol %) | (mol %) | (° C.) | (MPa) | (mol/l) |
| Ex3-1 PFP | EA | 99.99 | 0 | 0.01 | −18 | 0.39 | 0.041 |
| Ex3-2 PFP | EA | 99.98 | 0.01 | 0.01 | −16 | 0.50 | 0.054 |
| Ex3-3 PFP | EA | 99.89 | 0.1 | 0.01 | −17 | 0.63 | 0.067 |
| Ex3-4 PFP | EA | 99.49 | 0.5 | 0.01 | −16 | 1.08 | 0.116 |
| Ex3-5 PFP | EA | 98.99 | 1.0 | 0.01 | −15 | 1.41 | 0.151 |
| Ex3-6 PFP | EA | 98.49 | 1.5 | 0.01 | −14 | 2.08 | 0.224 |

To these polymer forming parts 12 wt % of particles 9B were added to yield the polymerizable compositions comprising swellable particles.

These polymerizable compositions were cured into films and subjected to the tensile test and the tear test. The results of the tensile test are shown in FIG. 6. In FIG. 6 it is shown that tensile strength increases as the polymer forming part becomes less cross-linked. Sample Ex3-1 contains no covalent cross-linker, leading to the lowest volume average cross-link density at 100° C. Sample Ex3-1 shows a large increase in tensile properties compared to the other samples.

The results of the tensile test and tear test are shown in Table 3.2, below.

TABLE 3.2
Example 3 Tensile Properties and Fracture Toughness

| | | | Tensile | |
|---|---|---|---|---|
| | v of Cured Polymer | Tensile | Strength | |
| | Forming Part | Modulus | (max stress, | G₀ |
| Sample | (100° C.) (mol/l) | (MPa) | MPa) | (J/m²) |
| Ex3-1 | 0.058 | 0.70 | 3.23 | 1400 |
| Ex3-2 | 0.078 | 0.65 | 4.68 | 1533 |
| Ex3-3 | 0.072 | 0.70 | 3.34 | 1470 |
| Ex3-4 | 0.116 | 0.94 | 0.98 | 778.7 |
| Ex3-5 | 0.151 | 1.08 | 0.96 | 510.0 |
| Ex3-6 | 0.224 | 1.44 | 0.52 | 296.5 |

A large increase in critical energy release rate G₀ is seen as the v of the cured polymer forming part decreases (the cured polymer forming part becomes less cross-linked). Particularly, when the v in mol/l at 100° C. of the cured polymer forming part becomes 0.2 mol/l or less, 0.16 mol/l or less, 0.15 mol/l or less, 0.13 mol/l or less, 0.12 mol/l or less, 0.115 mol/l or less, 0.11 mol/l or less, or 0.10 mol/l or less. Each of samples Ex3-1, Ex3-2, and Ex3-3 perform well in the tear test.

### Example 4—Influence of Swellable Particle Loading on Double Network Properties

Five polymerizable compositions containing swellable particles are formed according to the above procedures. Ethyl acrylate was used as the monomer in all polymerizable compositions. The wt % for EA, BDA, and photoinitiator are listed based on sum of the components making up the polymer forming part (i.e. the composition before adding swellable particles). The polymerizable compositions formed are shown in Table 4.1.

TABLE 4.1
Example 4 Polymerizable Compositions

| | | | Photo- | | |
|---|---|---|---|---|---|
| | EA | BDA | initiator | | |
| | (wt % of | (wt % of | (wt % of | | Swellable |
| | polymer | polymer | polymer | Swellable | Particles |
| | forming | forming | forming | Particle | (wt % of total |
| Sample | part) | part) | part) | Type | composition) |
| Ex4-1 | 99.89 | 0.1 | 0.01 | 9B | 16 |
| Ex4-2 | 99.89 | 0.1 | 0.01 | 9B | 14 |
| Ex4-3 | 99.89 | 0.1 | 0.01 | 9B | 12 |
| Ex4-4 | 99.89 | 0.1 | 0.01 | 9B | 10 |
| Ex4-5 | 99.89 | 0.1 | 0.01 | 9B | 8 |

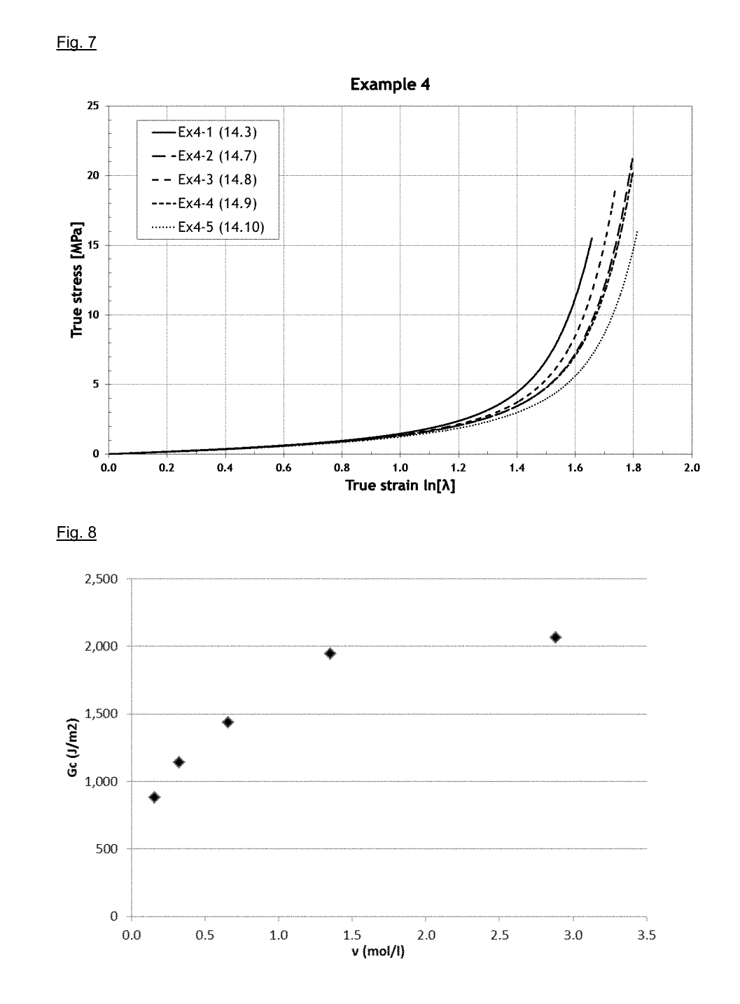

These polymerizable compositions were cured into films. All samples were subjected to the tensile test. All samples except Ex4-1 were subjected to the tear test. The tensile test results are shown in FIG. 7. The tear test results are show in Table 4.2, below.

TABLE 4.2
Example 4 Fracture Toughness

| | Swellable Particles | G₀ |
|---|---|---|
| Sample | (wt % of total composition) | (J/m²) |
| Ex4-1 | 16 | n.t. |
| Ex4-2 | 14 | 1631 |
| Ex4-3 | 12 | 1470 |
| Ex4-4 | 10 | 1341 |
| Ex4-5 | 8 | 1402 |

Although swellable particle loading appears to have a small effect in the tear test, a larger effect is seen in the tensile test. In the tensile test it can been seen that samples with higher swellable particle loading exhibit an earlier onset of strain hardening.

### Example 5—Influence of Swellable Particle Volume Average Cross-Link Density on Double Network Properties

### Formation of Example 5 Ethyl Acrylate (EA) Particles

In a 250 mL round-bottom flask containing 81.75 g MilliQ water, EA and BDA (90% purity) (inhibitor removed on an alumina column) are added along with sodium lauryl sulfate. So as to avoid all risk of unwanted reaction, a solution of potassium persulfate in distilled water is prepared separately in a 50 mL flask. These solutions are placed in an ice bath and bubbled in nitrogen for 45 minutes to reduce the risk of polymerization and early decomposition of the initiator. Once these two solutions are well degassed, the potassium persulfate solution is added to the 250 mL flask by syringe. The flask is then placed in a heated oil bath at 60° C. for 3.5 hours. The particles are obtained by placing a portion of this latex in an aluminum tray on a hot plate at 80° C. for one day. In order to evaporate off all traces of water, the samples are placed under vacuum for another day. Transparent particles are obtained.

The particles were formed using the amounts of each component as shown in Table 5.1, below.

TABLE 5.1
Example 5 Particle Compositions

| Particle | mol % | | | Sodium Lauryl | Potassium | Demineralized |
|---|---|---|---|---|---|---|
| Sample | BDA | EA (g) | BDA (g) | Sulfate (g) | Persulfate (g) | Water (g) |
| Ex 5-1P | 0.725 | 40.016 | 0.59 | 0.699 | 0.100 | 110.884 |
| Ex 5-2P | 1.45 | 39.91 | 1.15 | 0.692 | 0.098 | 110.069 |
| Ex 5-3P | 2.90 | 40.13 | 2.33 | 0.689 | 0.097 | 110.249 |
| Ex 5-4P | 5.80 | 40.02 | 4.76 | 0.716 | 0.101 | 110.087 |
| Ex 5-5P | 11.6 | 40.16 | 9.47 | 0.699 | 0.104 | 109.946 |

The particle compositions yielded particles with the component amounts as shown in Table 5.2.

TABLE 5.2
Example 5 Swellable Particles

| | | | | Theoretical |
|---|---|---|---|---|
| | cross-linker | cross-linker | EA amount | volume average |
| | amount in the | amount in the | in the | cross-link |
| Particle | particles | particles | particles | density |
| Sample | (mol %) | (wt %) | (mol %) | (mol/l) |
| Ex 5-1P | 0.725% | 1.43% | 99.275% | 0.1605 |
| Ex 5-2P | 1.45% | 2.83% | 98.55% | 0.3233 |
| Ex 5-3P | 2.9% | 5.6% | 97.1% | 0.6563 |
| Ex 5-4P | 5.8% | 10.9% | 94.2% | 1.353 |
| Ex 5-5P | 11.6% | 20.6% | 88.4% | 2.887 |

The theoretical volume average cross-link density is determined using equations (2) and (3), as described above. The density was assumed to be 1100 g/l.

Polymerizable compositions are prepared by first preparing a polymer forming part consisting of 0.01 mol % BDA, 99.98 mol % EA, and 0.01% photoinitiator. After preparing the polymer forming part, the stated amount of particles is mixed in. Samples formed from these polymerizable compositions are subjected to the tensile test to determine the tensile modulus E.

Fracture Energy (Gₑ) was determined using a single edge notch test. Samples of 20 mm in length, 5 mm in width, and approximately 1 mm in thickness were used. A 1 mm notch was introduced in the edge of the sample with a scalpel. The exact size of the notch was verified by image analysis. The sample was mounted on an Instron testing machine and deformed in tension at 100 μm/s in order to obtain tear curves. The Greensmith approach was used to calculate the fracture energy using equation (6):

$${G}_{c} = \frac{6 \cdot W \cdot c}{\sqrt{{λ}_{c}}} \qquad ( 6 )$$

wherein G₀ is the fracture energy, c is the initial length of the crack, λc is the strain at break measured in the single edge notch test, and W is the strain energy density calculated by integrating the stress versus engineering strain of un-notched samples until εc (εc=λc−1). The results are shown in Table 5.3.

TABLE 5.3
Example 5 Results

| | Theoretical volume | Swellable | | |
|---|---|---|---|---|
| | average cross-link | Particles | | |
| | density of particles | (wt % of total | E | G_{c} |
| Sample | (mol/l) | composition) | (MPa) | (J/m²) |
| 5-1 | 0.1605 | 12.27 | 0.58 | 882 |
| 5-2 | 0.3233 | 12.32 | 0.62 | 1,140 |
| 5-3 | 0.6563 | 12.69 | 0.77 | 1,435 |
| 5-4 | 1.353 | 12.91 | 0.80 | 1,946 |
| 5-5 | 2.887 | 13.00 | 0.75 | 2,062 |

The fracture energy of the samples greatly increases as the v of the particles increases (the particles become more cross-linked). FIG. 8 shows a plot of v vs. fracture energy. Fracture energy increases dramatically as v of the particles becomes 0.20 mol/l or more, and even more dramatically at 0.275 mol/l or more, 0.5 mol/l or more, 0.75 mol/l or more, or 1.0 mol/l or more.

### Example 6—Comparison of Double Network with Ethyl Acrylate Based Network Reinforced with Polystyrene Particles

### Formation of Example 6 Ethyl Acrylate (EA) Particles

In a 250 mL round-bottom flask containing 81.75 g MilliQ water, 40.127 g ethyl acrylate and 2.3321 g BDA (90% purity) (inhibitor removed on an alumina column) are added along with 0.6894 g sodium lauryl sulfate. So as to avoid all risk of unwanted reaction, a solution of initiator is prepared separately in a 50 mL flask: 0.0971 g potassium persulfate and 28.4946 g distilled water. These solutions are placed in an ice bath and bubbled in nitrogen for 45 minutes to reduce the risk of polymerization and early decomposition of the initiator. Once these two solutions are well degassed, the potassium persulfate solution is added to the 250 mL flask by syringe. The flask is then placed in a heated oil bath at 60° C. for 3.5 hours. The produced latex is in the form of a white liquid with bluish reflections characteristic of the formation of particles in the 100-nm range which scatter light. The particles are obtained by placing a portion of this latex in an aluminum tray on a hot plate at 80° C. for one day. In order to evaporate off all traces of water, the samples are placed under vacuum for another day. Transparent particles are obtained.

### Formation of Example 6 Polystyrene (PS) Particles

The polystyrene particles are formed according to the same procedure as the formation of the Example 6 ethyl acrylate particles, expect that EA is replaced with styrene (Aldrich, >99%) and the BDA is replaced by divinylbenzene (DVB, Aldrich, 80%). White particles are obtained.

The amounts of each component used in making the particles are summarized in Table 6.1, below.

TABLE 6.1
Example 6 Particle Compositions

| | | | Sodium Lauryl | Potassium | Demineralized |
|---|---|---|---|---|---|
| Particle | EA | BDA | Sulfate | Persulfate | Water |
| Type | (g) | (g) | (g) | (g) | (g) |
| EA | 40.127 | 2.3321 | 0.6894 | 0.0971 | 110.2486 |
| | | | Sodium Lauryl | Potassium | Demineralized |
| | Styrene | DVB | Sulfate | Persulfate | Water |
| | (g) | (g) | (g) | (g) | (g) |
| PS | 40.0145 | 1.3024 | 0.6745 | 0.0905 | 109.9825 |

Properties of the particles are shown in Table 6.2.

TABLE 6.2
Properties of Example 6 Particles

| | Tg | Estimated Particle Size |
|---|---|---|
| Particle Type | (° C.) | (nm) |
| EA | −2.2 | 100-300 |
| PS | 107.5 | 100-300 |

Three polymerizable compositions are formed and cured as follows. The unreinforced sample (Ex6-1) is cured into a film by placing in a mold consisting of two glass plates separated by a Teflon® tube that ensures a good seal. The thickness of the sample is 1 mm as determined by 1 mm thick metal plates. The polymerizable compositions are bubbled in nitrogen for 1 hour before being placed in the mold. The polymerizable composition is injected into the mold and placed under a Vilber Lourmat V 215.L UV lamp modified with a siliconized PET foil having an intensity equal to 10 μW/cm² for 2.75 hours while in a glovebox under nitrogen. After polymerization, the sample is demolded and placed to dry under vacuum and at 80° C. to remove unreacted monomer.

The reinforced samples (Ex 6-2 and Ex6-3) are formed by first placing 1.00 g of particles in 9.00 g EA to swell overnight under mechanical agitation. Nitrogen is then bubbled through this solution for 45 min before introduction into the glovebox. At this stage it is possible that some of the monomer may have evaporated off since EA is quite volatile. The quantity of EA is readjusted once in the glovebox. BDA is then added at 0.01% molar along with 0.01% of photoinitiator. The polymerizable composition is injected into the mold and placed under a Vilber Lourmat V 215 L UV lamp modified with a siliconized PET foil having an intensity equal to 10 μW/cm² for 2.75 hours while in a glovebox under nitrogen. Once polymerized, the network is placed to dry under vacuum at 80° C. overnight to eliminate unreacted monomer. The formulations of these polymerizable compositions (after readjustment of EA) are shown in Table 6.3. The values for wt % reported are based on the total amount of EA and particles.

TABLE 6.3
Example 6 Polymerizable Compositions

| | | | | BDA | Photoinitiator |
|---|---|---|---|---|---|
| | Particle | Particles | EA | (mol % of total | (mol % of total |
| Sample | Type | (wt %) | (wt %) | composition) | composition) |
| Ex6-1 | None | — | 99.98 | 0.01 | 0.01 |
| Ex6-2 | PS | 10 | 90 | 0.01 | 0.01 |
| Ex6-3 | EA | 10 | 90 | 0.01 | 0.01 |

The Tg and E′ are measured for each film. The results are shown in Table 6.4.

TABLE 6.4
Properties of Example 6 Samples

| | | | | E | v |
|---|---|---|---|---|---|
| | Particle | Particles | Tg | (MPa @ | (100° C.) |
| Sample | Type | (wt %) | (° C.) | 23° C.) | (mol/l) |
| Ex6-1 | None | — | −10.5 | 0.53 | 0.0262 |
| Ex6-2 | PS | 11.21 | −10.5 and | 1.70 | n.t. |
| | | | 107.5 | | |
| Ex6-3 | EA | 12.69 | −10.6 | 0.80 | n.t. |

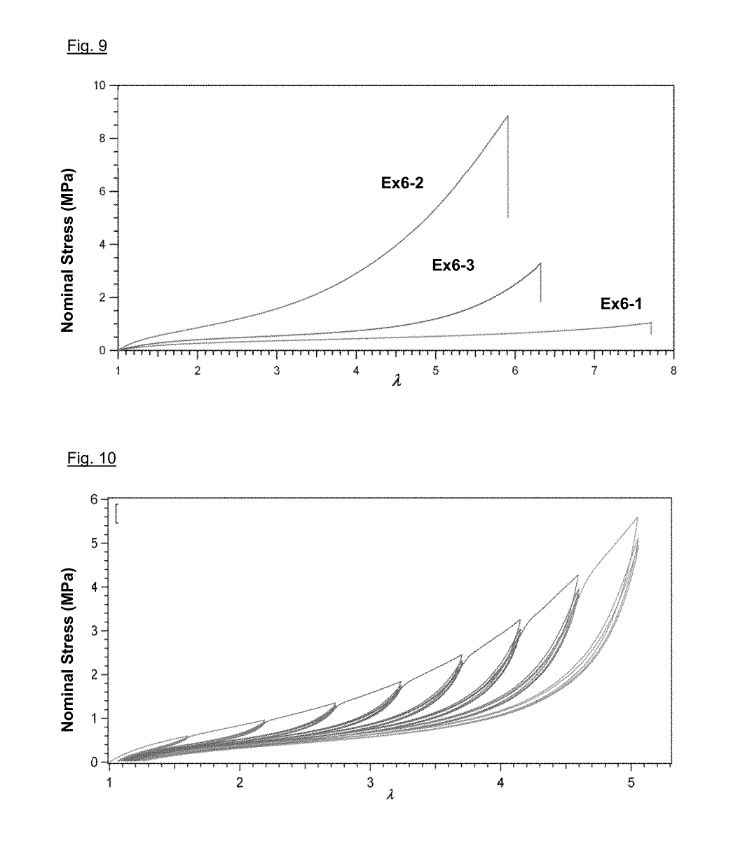

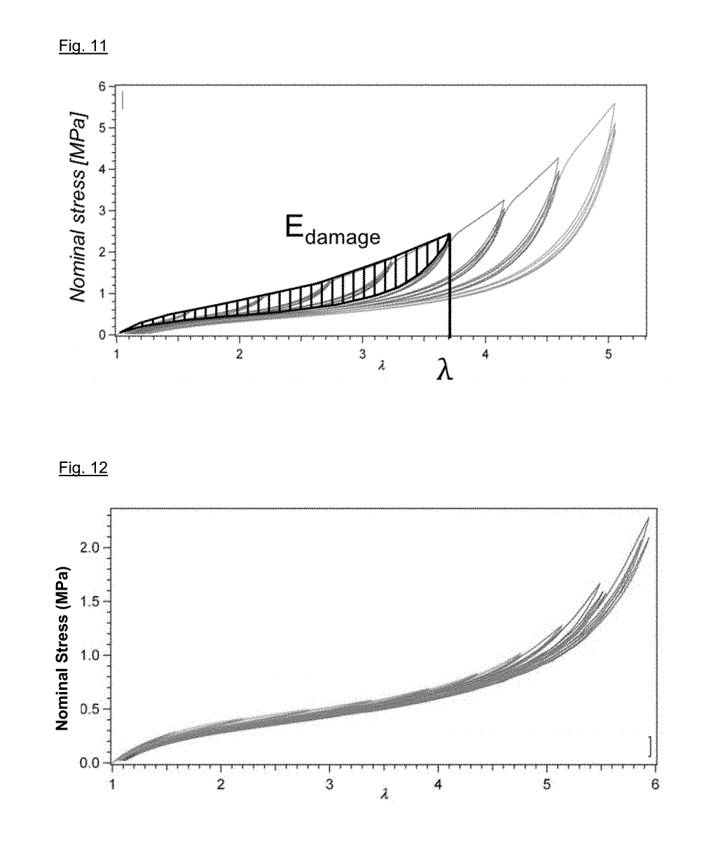

The samples were subjected to the tensile test and the hysteresis test. FIG. 9 shows the result of the tensile test. FIGS. 10 and 11 show the result of the hysteresis test for Example 6-2 (PS reinforced). FIG. 12 is the result of the hysteresis test for Example 6-3 (EA reinforced).

As can be seen from the tensile curves in FIG. 9 and the modulus in Table 6.4, the polystyrene reinforced film (Ex6-2) is substantially stiffer than the unreinforced film (Ex6-1), while the EA reinforced film (Ex6-3) has a modulus closer to the unreinforced film (Ex6-1). Therefore, while reinforcing the film with glassy, high Tg PS particles (Ex6-2) improves stress at break, this comes at the expense of a substantial increase in modulus. Reinforcing with the soft (low Tg) EA particles increases strain hardening and stress at break while keeping the composite material soft.

Moreover, the polystyrene reinforced film shows substantial hysteresis upon cyclic loading as shown in FIG. 10, with the sample softening and experiencing delayed strain hardening depending on the maximum deformation experienced during the previous cycle. This hysteresis can be quantified as the total amount of energy which has been dissipated at the end of each cycle (E_{damage}), as highlighted in FIG. 11. FIG. 11 illustrates the E_{damage} for a PS reinforced sample at a given λₘₐₓ (fifth extension/relaxation cycle).

In contrast, the EA reinforced film shows substantially no hysteresis in FIG. 12. Therefore, it can be concluded that the reinforcement mechanism provided by the EA particles is different than the reinforcement mechanism provided by the PS particles.

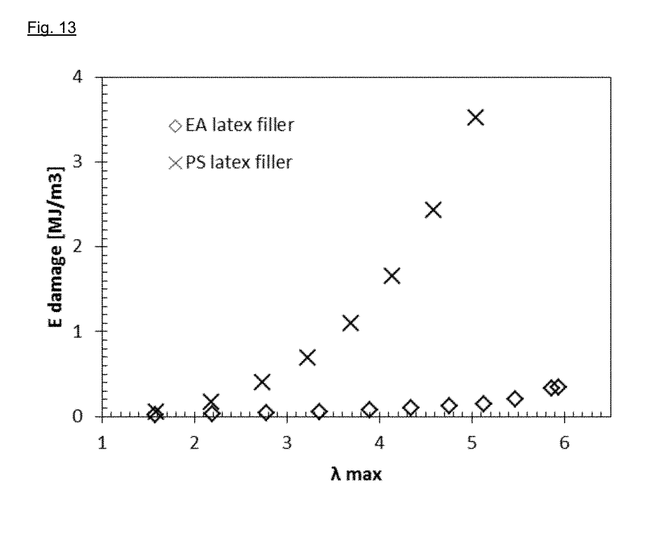

This is further demonstrated in FIG. 13, wherein the energy dissipated as a result of the damage of the sample (E_{damage}) is plotted for both the polystyrene reinforced film (Ex6-2) and the EA reinforced film (Ex6-3). The EA reinforced sample dissipates very little energy over several extension/relaxation cycles, whereas the PS reinforced film exhibits substantial energy dissipation. This indicates that the PS reinforced film undergoes substantial hysteresis, whereas the EA reinforced film undergoes no substantial hysteresis.

### Example 7—Influence of Swellable Particle and Polymer Forming Part Monomer Type

Three polymer forming part compositions are formed. Their compositions are shown in Table 7.1.

TABLE 7.1
Example 7 Polymer Forming Part Compositions

| | | | | Photo- | | | |
|---|---|---|---|---|---|---|---|
| | | | | initiator | | | |
| | | Monomer | BDA | amount | Tg | E′ (100° C.) | v (100° C.) |
| Sample | Monomer | (wt %) | (wt %) | (wt %) | (° C.) | (MPa) | (mol/l) |
| Ex7 EA | EA | 99.96 | 0.02 | 0.02 | −16 | 0.56 | 0.0596 |
| PFP | | | | | | | |
| Ex7 BA | BA | 99.96 | 0.02 | 0.02 | −47 | 0.29 | 0.0306 |
| PFP | | | | | | | |
| EX7 | BACOEA | 99.97 | 0.012 | 0.016 | −7 | 0.18 | 0.0194 |
| BACOEA | | | | | | | |
| PFP | | | | | | | |

Polymerizable compositions are formed according to the above procedures by adding swellable particles to Ex 7-1 PFP and Ex7-2 PFP. The formed polymerizable compositions are shown in Table 7.2.

TABLE 7.2
Example 7 Polymerizable Compositions

| | | | Particle | |
|---|---|---|---|---|
| | | Particle | Amount | Swelling |
| Sample | PFP | Type | (wt %) | Ratio |
| Ex 7-1 | Ex 7 EA PFP | 10B (EA) | 14 | 480% |
| Ex 7-2 | Ex 7 EA PFP | 28 (BA) | 12 | 469% |
| Ex 7-3 | Ex 7 BA PFP | 10B (EA) | 14 | 350% |
| Ex 7-4 | EX7 BACOEA | 28 (BA) | 12 | 887% |
| | PFP | | | |

Films are formed from the polymerizable compositions. Films are also formed from Ex7 EA PFP, Ex7 BA PFP, and EX7 BACOEA PFP. The films are subjected to the tensile test and the tear test. The results of the tensile test, and tear test are shown in Table 7.3. The factor is the factor increase over the polymer forming part without particles.

TABLE 7.3
Example 7 Results

| | | | Tensile | | Max | | | |
|---|---|---|---|---|---|---|---|---|
| | Part. | PFP | Modulus | | Stress | | G₀ | |
| Sample | Type | Type | (MPa) | Factor | (MPa) | Factor | (J/m²) | Factor |
| Ex7 EA | N/A | EA | 0.54 | N/A | 1.33 | N/A | 875 | N/A |
| PFP | | | | | | | | |
| Ex7-1 | EA | EA | 0.65 | 1.19 | 4.22 | 3.17 | 2784 | 3.18 |
| Ex7-2 | BA | EA | 0.55 | 1.02 | 3.59 | 2.69 | 1992 | 2.28 |
| Ex7 BA | N/A | BA | 0.26 | N/A | 0.78 | N/A | 427 | N/A |
| PFP | | | | | | | | |
| Ex7-3 | EA | BA | 0.29 | 1.15 | 1.63 | 2.08 | 865 | 2.03 |
| Ex7 | N/A | BACOEA | 0.30 | N/A | 0.78 | N/A | 281 | N/A |
| BACOEA | | | | | | | | |
| PFP | | | | | | | | |
| Ex7-4 | BA | BACOEA | 0.21 | 0.70 | 0.86 | 1.11 | 654 | 2.33 |

### Example 8—Double Network Film Formed from Polymer Forming Part Emulsified in a Dispersing Medium

Example 8-1: a UV-cured film is formed from a waterborne dispersion of particles and polymer forming parts. To 44 grams of Ex7 BACOEA PFP, an aqueous suspension of BA latex 28 (40% solids in water, 15 gram dry latex equivalent) are added. The mixture is stirred for several hours and poured into an open mold, then allowed to dry (until weight stabilized). After drying, the film is placed in an inert atmosphere and cured under UV light. The cured film is transparent and exhibits strain-hardening behavior when manually stretched.

Example 8-2: a UV-cured film is formed as a solvent-borne system. 6 grams dried BA latex 28 and 9 grams of ethanol are added to 44 g of Ex7 BACOEA PFP. The mixture is stirred for several hours and poured into an open mold, then allowed to dry (until weight stabilized). After drying, the film is placed in an inert atmosphere and cured under UV light. The cured film is transparent and exhibits strain-hardening behavior when manually stretched.

### Example 9—Polymerizable Composition Comprising Particles that are Multi-Network Polymers

The two compositions shown in Table 9.1 are first prepared.

TABLE 9.1
Example 9 Starting Compositions

| | | EA | BDA | Photo-initiator |
|---|---|---|---|---|
| Sample | Description | (wt %) | (wt %) | (wt %) |
| 9A | EA with 0.01 mol % BDA | 99.96 | 0.020 | 0.016 |
| 9B | EA with 2.8 mol % BDA | 94.60 | 5.395 | 0.015 |

Two identical films are made by curing Sample 9B. Films formed from 9B will be referred to as 9SN. One of the 9SN films is soaked in a bath of formulation 9A to equilibrium (overnight) and then wiped off on a paper towel and placed between glass plates. This mold is placed under nitrogen flush and cured to form a double network film (9DN). Based on comparing the mass of film 9DN with film 9SN, the effective composition of polymer networks is calculated to determine the swelling ratio. The swelling ratio is 234%.

The 9.1 SN and 9.1 DN films are frozen in dry ice and then cryomilled using a Retsch mill with a 0.5 mm sieve to produce particles having the same composition as the original films. Formulations are formed using the composition of 9.1A as polymer forming part. The particles are allowed to swell to equilibrium and the swelling ratio determined by the gel test. The makeup of the formed compositions are shown in Table 9.2.

TABLE 9.2
Example 9 Polymerizable Compositions

| | Description | | | | |
|---|---|---|---|---|---|
| | of film formed | Amount | Amount | | |
| | from these | 9.1SN | 9.1DN | Amount | Swelling |
| Sam- | polymerizable | Particles | Particles | 9A | Ratio of |
| ple | compositions | (wt %) | (wt %) | (wt %) | Particles |
| 9.1 | Unreinforced film | — | — | 100 | N/A |
| 9.2 | Cross-linked | 12 | — | 88 | 356% |
| | particle rein- | | | | |
| | forced film | | | | |
| 9.3 | Double network | — | 12 | 88 | 290% |
| | particle rein- | | | | |
| | forced film | | | | |

Films are formed by polymerizing polymerizable compositions 9.1, 9.2, and 9.3. The films were subjected to the tensile test and tear test. The large size of the particles created difficulty in injecting 9.2 and 9.3 into the mold via the nozzle. Moreover, the size of the swollen particles is on the same order as the thickness of the film. Consequently, films 9.2 and 9.3 were inhomogeneous. The inhomogeneity impacted the reliability of the tensile test, as evidenced by a significant spread in the data. Although the inhomogeneity had a lesser effect on the reliability of the tear test, the modulus obtained from the tensile test is used to calculate the critical energy release rate (G₀). Thus the lack of reliability of the tear test may also impact the reported G₀. The critical energy release rate is reported for each sample in Table 9.3, below.

TABLE 9.3
Example 9 Results

| | | Critical energy |
|---|---|---|
| | Description of | release rate G₀ |
| Sample | film | (J/m²) |
| 9.1 | Unreinforced film | 1746 |
| 9.2 | Cross-linked particle | 3932 |
| | reinforced film | |
| 9.3 | Double network particle | 4441 |
| | reinforced film | |

### Example 10—Effect of High Tg and Low Swelling on Transparency

A polymer forming part is formed in accordance with Example 3. The polymer forming part compositions, and their Tg and volume average cross-link density once 90% or more of the polymerizable groups are polymerized, are as shown in Table 10.1, below. Volume average cross-link density (v) is determined via DMTA.

TABLE 10.1
Example 10 Polymer forming part Composition

| | | | | Photo- | | E′ | v |
|---|---|---|---|---|---|---|---|
| | Monomer | Monomer | BDA | initiator | Tg | (100° C.) | (100° C.) |
| Sample | Type | (mol %) | (mol %) | (mol %) | (100° C.) | (MPa) | (mol/l) |
| Ex10 PFP | EA | 99.89 | 0.1 | 0.01 | −17 | 0.63 | 0.067 |

To this polymer forming part 12 wt % of particles (either 9B or 012) are added to yield the polymerizable compositions shown in Table 10.2. These polymerizable compositions are cured in accordance with Example 3. Dried latex 012 was cryomilled into <0.5 mm chunks before the gel test to speed up swelling. The accuracy of the reported swelling ratio is +/−50%.

TABLE 10.2
Example 10 Polymerizable Compositions

| | | | Particle | | |
|---|---|---|---|---|---|
| | | Particle | polymer | | |
| | Particle | monomer | Tg* | Particle | Swelling |
| Sample | Type | type | (° C.) | (wt %) | Ratio |
| Ex10-1 | 9B | EA | −21 | 12 | 527% |
| Ex10-2 | 012 | MMA | 105 | 12 | 194% |

*value obtained from published sources, not measured.

Cured films formed from the polymerizable compositions of Ex10 PFP, Ex10-1, and Ex10-2 were examined visually. Ex10 PFP was transparent. Ex10-1, containing particles with a low Tg and high swelling ratio in the PFP, was also transparent. Ex10-2, containing particles with high Tg and a low swelling ratio in the PFP, was hazy.

### Supplementary Disclosure of Certain Exemplary Embodiments

Embodiment 101 of the invention is a polymerizable composition comprising:
a. a polymer forming part comprising
   i. one or more compounds comprising a polymerizable group, and
   ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 1.0 mol/l or less,
b. swellable particles comprising cross-links and having
   i. a Tg of less than 25° C., as determined by DMTA after drying the swellable particles in air until they form a film and then drying the film for 16 hours in a vacuum oven at 80° C.,
   ii. a 1/T₂ of 0.1 ms⁻¹ or more, where T₂ is the time at which the signal amplitude has decayed to 1/e of its original value as determined by solid state NMR T₂ relaxometry at 110° C. using a HEPS, and
wherein the swellable particles swell to a swelling ratio of 250% or more by mass from their non-swollen state if the swellable particles are swollen to equilibrium in a mixture consisting of the polymer forming part and the swellable particles,
c. optionally, a solvent, and
d. optionally, a filler.

Embodiment 102 of the invention is the polymerizable composition of Embodiment 101, wherein the polymerizable composition contains less than 5 wt % of water, based on the total weight of the polymerizable composition.

Embodiment 103 of the invention is the polymerizable composition according to Embodiment 101 or 102, wherein the viscosity of the polymerizable composition is from 0.01 to 3000 Pa-s at 25° C. measured using a shear rate of 50 s⁻¹, preferably from 0.01 to 2500 Pa-s, more preferably from 0.01 to 2000 Pa-s.

Embodiment 104 of the invention is the polymerizable composition according to any one of Embodiments 101-103, wherein the swellable particles have an unswollen particle diameter of from 10 nm to 1 mm, preferably from 10 nm to 500 μm preferably from 10 nm to 500 μm, more preferably from 10 nm to 10 μm, more preferably from 10 nm to 3 μm, when measured by photon correlation spectroscopy in water.

Embodiment 105 of the invention is the polymerizable composition according to any one of Embodiments 101-104, wherein the swellable particles have a 1/T₂ of 0.1 ms⁻¹ or more, preferably 0.2 ms⁻¹ or more, more preferably 0.3 ms⁻¹ or more, more preferably 0.4 ms⁻¹ or more, more preferably 0.5 ms⁻¹ or more, more preferably 0.6 ms⁻¹ or more, more preferably 0.7 ms⁻¹ or more, more preferably 0.8 ms⁻¹ or more, where T₂ is the time at which the signal amplitude has decayed to 1/e of its original value as determined by solid state NMR T₂ relaxometry at 110° C. using a HEPS.

Embodiment 106 of the invention is the polymerizable composition according to any one of Embodiments 101-104, wherein the swellable particles have a 1/T₂ of from 0.1 ms⁻¹ to 10 ms⁻¹, preferably from 0.2 ms⁻¹ to 10 ms⁻¹, more preferably from 0.3 ms⁻¹ to 10 ms⁻¹, more preferably from 0.4 ms⁻¹ to 10 ms⁻¹, more preferably from 0.5 ms⁻¹ to 10 ms⁻¹, more preferably from 0.6 ms⁻¹ to 10 ms⁻¹, more preferably from 0.7 ms⁻¹ to 10 ms⁻¹, more preferably from 0.8 ms⁻¹ to 10 ms⁻¹, where T₂ is the time at which the signal amplitude has decayed to 1/e of its original value as determined by solid state NMR T₂ relaxometry at 110° C. using a HEPS.

Embodiment 107 of the invention is the polymerizable composition according to any one of Embodiments 101-104, wherein the swellable particles have a 1/T₂ of from 0.1 ms⁻¹ to 5 ms⁻¹, preferably from 0.2 ms⁻¹ to 5 ms⁻¹, more preferably from 0.3 ms⁻¹ to 5 ms⁻¹, more preferably from 0.4 ms⁻¹ to 5 ms⁻¹, more preferably from 0.5 ms⁻¹ to 5 ms⁻¹, more preferably from 0.6 ms⁻¹ to 5 ms⁻¹, more preferably from 0.7 ms⁻¹ to 5 ms⁻¹, more preferably from 0.8 ms⁻¹ to 5 ms⁻¹, where T₂ is the time at which the signal amplitude has decayed to 1/e of its original value as determined by solid state NMR T₂ relaxometry at 110° C. using a HEPS.

Embodiment 108 of the invention is the polymerizable composition according to any one of Embodiment 101-104, wherein the swellable particles are formed from a particle composition, the swellable particles have a volume average cross-link density (v) at 100° C. of 0.01 mol/l or more, preferably 0.025 mol/l or more, more preferably 0.05 mol/l or more, more preferably 0.1 mol/l or more, more preferably 0.20 mol/l or more, more preferably 0.275 mol/l or more, more preferably 0.5 mol/l or more, more preferably 0.75 mol/l or more, more preferably 1.0 mol/l or more, as measured by DMTA on a film formed by curing the particle composition, such that 90% or more of the polymerizable groups in the particle composition are polymerized.

Embodiment 109 of the invention is the polymerizable composition according to any one of Embodiment 101-104, wherein the swellable particles are formed from a particle composition, the swellable particles have a volume average cross-link density (v) at 100° C. of from 0.01 to 10 mol/l, preferably from 0.025 to 10 mol/l, more preferably from 0.05 g/mol to 10 mol/l, more preferably from 0.1 to 10 mol/l, more preferably from 0.2 to 10 mol/l, more preferably from 0.275 to 10 mol/l, more preferably from 0.5 to 10 mol/l, more preferably from 0.75 to 10 mol/l, more preferably from 1.0 to 10 mol/l, as measured by DMTA on a film formed by curing the particle composition, such that 90% or more of the polymerizable groups in the particle composition are polymerized.

Embodiment 110 of the invention is the polymerizable composition according to any one of Embodiment 101-104, wherein the swellable particles are formed from a particle composition, the swellable particles have a volume average cross-link density (v) at 100° C. of from 0.01 to 7 mol/l, preferably from 0.025 to 7 mol/l, more preferably from 0.05 g/mol to 7 mol/l, more preferably from 0.1 to 7 mol/l, more preferably from 0.2 to 7 mol/l, more preferably from 0.275 to 7 mol/l, more preferably from 0.5 to 7 mol/l, more preferably from 0.75 to 7 mol/l, more preferably from 1.0 to 7 mol/l, as measured by DMTA on a film formed by curing the particle composition, such that 90% or more of the polymerizable groups in the particle composition are polymerized.

Embodiment 111 of the invention is the polymerizable composition according to any one of Embodiment 101-104, wherein the swellable particles are formed from a particle composition, the swellable particles have a volume average cross-link density (v) at 100° C. of from 0.01 to 5.5 mol/l, preferably from 0.025 to 5.5 mol/l, more preferably from 0.05 g/mol to 5.5 mol/l, more preferably from 0.1 to 5.5 mol/l, more preferably from 0.2 to 5.5 mol/l, more preferably from 0.275 to 5.5 mol/l, more preferably from 0.5 to 5.5 mol/l, more preferably from 0.75 to 5.5 mol/l, more preferably from 1.0 to 5.5 mol/l, as measured by DMTA on a film formed by curing the particle composition, such that 90% or more of the polymerizable groups in the particle composition are polymerized.

Embodiment 201 of the invention is a polymerizable composition comprising:
a. a polymer forming part comprising
   i. one or more compounds comprising a polymerizable group, and
   ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 1.0 mol/l or less,
b. swellable particles comprising cross-links, being formed from a particle composition, and having
   i. a Tg of less than 25° C., as determined by DMTA after drying the swellable particles in air until they form a film and then drying the film for 16 hours in a vacuum oven at 80° C.,
   ii. a volume average cross-link density (v) at 100° C. of 0.01 mol/l or more, as measured by DMTA on a film formed by curing the particle composition, such that 90% or more of the polymerizable groups in the particle composition are polymerized, and
wherein the swellable particles swell to a swelling ratio of 250% or more by mass from their non-swollen state if the swellable particles are swollen to equilibrium in a mixture consisting of the polymer forming part and the swellable particles,
c. optionally, a solvent, and
d. optionally, a filler.

Embodiment 202 of the invention is the polymerizable composition of Embodiment 201, wherein the polymerizable composition contains less than 5 wt % of water, based on the total weight of the polymerizable composition.

Embodiment 203 of the invention is the polymerizable composition according to Embodiment 201 or 202, wherein the viscosity of the polymerizable composition is from 0.01 to 3000 Pa-s at 25° C. measured using a shear rate of 50 s⁻¹, preferably from 0.01 to 2500 Pa-s, more preferably from 0.01 to 2000 Pa-s.

Embodiment 204 of the invention is the polymerizable composition according to any one of Embodiments 201-203, wherein the swellable particles have an unswollen particle diameter of from 10 nm to 1 mm, preferably from 10 nm to 800 μm, preferably from 10 nm to 500 μm, more preferably from 10 nm to 10 μm, more preferably from 10 nm to 3 μm, when measured by photon correlation spectroscopy in water.

Embodiment 205 of the invention is the polymerizable composition according to any one of Embodiments 201-204, wherein the swellable particles have a 1/T₂ of 0.1 ms⁻¹ or more, preferably 0.2 ms⁻¹ or more, more preferably 0.3 ms⁻¹ or more, more preferably 0.4 ms⁻¹ or more, more preferably 0.5 ms⁻¹ or more, more preferably 0.6 ms⁻¹ or more, more preferably 0.7 ms⁻¹ or more, more preferably 0.8 ms⁻¹ or more, where T₂ is the time at which the signal amplitude has decayed to 1/e of its original value as determined by solid state NMR T₂ relaxometry at 110° C. using a HEPS.

Embodiment 206 of the invention is the polymerizable composition according to any one of Embodiments 201-204, wherein the swellable particles have a 1/T₂ of from 0.1 ms⁻¹ to 10 ms⁻¹, preferably from 0.2 ms⁻¹ to 10 ms⁻¹, more preferably from 0.3 ms⁻¹ to 10 ms⁻¹, more preferably from 0.4 ms⁻¹ to 10 ms⁻¹, more preferably from 0.5 ms⁻¹ to 10 ms⁻¹, more preferably from 0.6 ms⁻¹ to 10 ms⁻¹, more preferably from 0.7 ms⁻¹ to 10 ms⁻¹, more preferably from 0.8 ms⁻¹ to 10 ms⁻¹, where T₂ is the time at which the signal amplitude has decayed to 1/e of its original value as determined by solid state NMR T₂ relaxometry at 110° C. using a HEPS.

Embodiment 207 of the invention is the polymerizable composition according to any one of Embodiments 201-204, wherein the swellable particles have a 1/T₂ of from 0.1 ms⁻¹ to 5 ms⁻¹, preferably from 0.2 ms⁻¹ to 5 ms⁻¹, more preferably from 0.3 ms⁻¹ to 5 ms⁻¹, more preferably from 0.4 ms⁻¹ to 5 ms⁻¹, more preferably from 0.5 ms⁻¹ to 5 ms⁻¹, more preferably from 0.6 ms⁻¹ to 5 ms⁻¹, more preferably from 0.7 ms⁻¹ to 5 ms⁻¹, more preferably from 0.8 ms⁻¹ to 5 ms⁻¹, where T₂ is the time at which the signal amplitude has decayed to 1/e of its original value as determined by solid state NMR T₂ relaxometry at 110° C. using a HEPS.

Embodiment 208 of the invention is the polymerizable composition according to any one of Embodiment 201-204, wherein the swellable particles are formed from a particle composition, the swellable particles have a volume average cross-link density (v) at 100° C. of 0.01 mol/l or more, preferably 0.025 mol/l or more, more preferably 0.05 mol/l or more, more preferably 0.1 mol/l or more, more preferably 0.20 mol/l or more, more preferably 0.275 mol/l or more, more preferably 0.5 mol/l or more, more preferably 0.75 mol/l or more, more preferably 1.0 mol/l or more, as measured by DMTA on a film formed by curing the particle composition, such that 90% or more of the polymerizable groups in the particle composition are polymerized.

Embodiment 209 of the invention is the polymerizable composition according to any one of Embodiment 201-204, wherein the swellable particles are formed from a particle composition, the swellable particles have a volume average cross-link density (v) at 100° C. of from 0.01 to 10 mol/l, preferably from 0.025 to 10 mol/l, more preferably from 0.05 g/mol to 10 mol/l, more preferably from 0.1 to 10 mol/l, more preferably from 0.2 to 10 mol/l, more preferably from 0.275 to 10 mol/l, more preferably from 0.5 to 10 mol/l, more preferably from 0.75 to 10 mol/l, more preferably from 1.0 to 10 mol/l, as measured by DMTA on a film formed by curing the particle composition, such that 90% or more of the polymerizable groups in the particle composition are polymerized.

Embodiment 210 of the invention is the polymerizable composition according to any one of Embodiment 201-204, wherein the swellable particles are formed from a particle composition, the swellable particles have a volume average cross-link density (v) at 100° C. of from 0.01 to 7 mol/l, preferably from 0.025 to 7 mol/l, more preferably from 0.05 g/mol to 7 mol/l, more preferably from 0.1 to 7 mol/l, more preferably from 0.2 to 7 mol/l, more preferably from 0.275 to 7 mol/l, more preferably from 0.5 to 7 mol/l, more preferably from 0.75 to 7 mol/l, more preferably from 1.0 to 7 mol/l, as measured by DMTA on a film formed by curing the particle composition, such that 90% or more of the polymerizable groups in the particle composition are polymerized.

Embodiment 211 of the invention is the polymerizable composition according to any one of Embodiment 201-204, wherein the swellable particles are formed from a particle composition, the swellable particles have a volume average cross-link density (v) at 100° C. of from 0.01 to 5.5 mol/l, preferably from 0.025 to 5.5 mol/l, more preferably from 0.05 g/mol to 5.5 mol/l, more preferably from 0.1 to 5.5 mol/l, more preferably from 0.2 to 5.5 mol/l, more preferably from 0.275 to 5.5 mol/l, more preferably from 0.5 to 5.5 mol/l, more preferably from 0.75 to 5.5 mol/l, more preferably from 1.0 to 5.5 mol/l, as measured by DMTA on a film formed by curing the particle composition, such that 90% or more of the polymerizable groups in the particle composition are polymerized.

Embodiment 212 of the invention is the polymerizable composition according to any one of Embodiments 101-211, wherein the swellable particles swell to a swelling ratio of 300% or more, preferably 325% or more, more preferably 350% or more, more preferably 375% or more, more preferably 400% or more, or more preferably 425% or more by mass from their non-swollen state if the swellable particles are swollen to equilibrium in a mixture consisting of the polymer forming part and the swellable particles.

Embodiment 213 of the invention is the polymerizable composition according to any one of Embodiments 101-211, wherein the swellable particles swell to a swelling ratio of from 250% to 5000%, preferably from 300% to 5000%, preferably from 325% to 5000%, more preferably from 350% to 5000%, more preferably from 375% to 5000%, more preferably from 400% to 5000%, more preferably from 425% to 5000% by mass from their non-swollen state if the swellable particles are swollen to equilibrium in a mixture consisting of the polymer forming part and the swellable particles.

Embodiment 214 of the invention is the polymerizable composition according to any one of Embodiments 101-211, wherein the swellable particles swell to a swelling ratio of from 250% to 2500%, preferably from 300% to 2500%, preferably from 325% to 2500%, more preferably from 350% to 2500%, more preferably from 375% to 2500%, more preferably from 400% to 2500%, more preferably from 425% to 2500% by mass from their non-swollen state if the swellable particles are swollen to equilibrium in a mixture consisting of the polymer forming part and the swellable particles.

Embodiment 215 of the invention is the polymerizable composition according to any one of Embodiments 101-211, wherein the swellable particles swell to a swelling ratio of from 250% to 1500%, preferably from 300% to 1500%, preferably from 325% to 1500%, more preferably from 350% to 1500%, more preferably from 375% to 1500%, more preferably from 400% to 1500%, more preferably from 425% to 1500% by mass from their non-swollen state if the swellable particles are swollen to equilibrium in a mixture consisting of the polymer forming part and the swellable particles.

Embodiment 216 of the invention is the polymerizable composition according to any one of Embodiments 101-215, wherein the swellable particles have a Tg of from −130° C. to 25° C. as determined by DMTA after drying the swellable particles in air until they form a film and then drying the film for 16 hours in a vacuum oven at 80° C.

Embodiment 217 of the invention is the polymerizable composition according to any one of Embodiments 101-216, wherein a composition consisting of the polymer forming part, if 90% or more of the polymerizable groups in the polymer forming part are polymerized, has a Tg as determined by DMTA of from −130° C. to 25° C.

Embodiment 218 of the invention is the polymerizable composition according to any one of Embodiments 101-217, wherein a composition consisting of the polymer forming part, if 90% or more of the polymerizable groups in the polymer forming part are polymerized, has a volume average cross-link density at 100° C. as determined by DMTA of 10 mol/l or less, preferably 5.0 mol/l or less, more preferably 3.0 mol/l or less, more preferably 1.0 mol/l or less, more preferably 0.5 mol/l or less, more preferably 0.2 mol/l or less, more preferably 0.16 mol/l or less, more preferably 0.15 mol/l or less, more preferably 0.13 mol/l or less, more preferably 0.12 mol/l or less, more preferably 0.115 mol/l or less, more preferably 0.11 mol/l or less, more preferably 0.1 mol/l or less, more preferably 0.085 mol/l or less, more preferably 0.075 mol/l or less.

Embodiment 219 of the invention is the polymerizable composition according to any one of Embodiments 101-217, wherein a composition consisting of the polymer forming part, if 90% or more of the polymerizable groups in the polymer forming part are polymerized, has a volume average cross-link density at 100° C. as determined by DMTA of from 0.005 mol/l to 10 mol/l, preferably from 0.005 mol/l to 5.0 mol/l, more preferably from 0.005 mol/l to 3.0 mol/l, more preferably from 0.005 mol/l to 1 mol/l, more preferably from 0.005 mol/l to 0.5 mol/l, more preferably from 0.005 mol/l to 0.2 mol/l, more preferably from 0.005 mol/l to 0.16 mol/l, more preferably from 0.005 mol/l to 0.15 mol/l, more preferably from 0.005 mol/l to 0.13 mol/l, more preferably from 0.005 mol/l to 0.12 mol/l, more preferably from 0.005 mol/l to 0.115 mol/l, more preferably from 0.005 mol/l to 0.11 mol/l, more preferably from 0.005 mol/l to 0.1 mol/l, more preferably from 0.005 mol/l to 0.085 mol/l, more preferably from 0.005 mol/l to 0.075 mol/l.

Embodiment 220 of the invention is the polymerizable composition according to any one of Embodiments 101-219, wherein the one or more compounds comprising a polymerizable group in the polymer forming part comprise a compound that is polymerizable by free-radical polymerization, cationic polymerization, anionic polymerization, reduction oxidation, addition polymerization, or polycondensation.

Embodiment 221 of the invention is the polymerizable composition according to any one of Embodiments 101-220, wherein the one or more compounds comprising a polymerizable group in the polymer forming part comprise a polymerizable group selected from the group consisting of hydroxy, amino, sulpho, keto, ester, amide, acid, anhydride, acetoxy, and acetal.

Embodiment 222 of the invention is the polymerizable composition according to any one of Embodiments 101-221, wherein the one or more compounds comprising a polymerizable group in the polymer forming part comprise a polymerizable group the polymerizable group is selected from the group consisting of hydroxy, amino, epoxy, oxetane, (meth)acrylate, (meth)acrylamide, carboxyl, isocyanate, and vinylether, preferably (meth)acrylate.

Embodiment 223 of the invention is the polymerizable composition according to any one of Embodiments 101-222, wherein more than one different type of polymerizable group is present in the polymer forming part.

Embodiment 224 of the invention is the polymerizable composition according to any one of Embodiments 101-223, the polymer forming part comprises one or more components comprising one (meth)acrylate group, one or more components comprising more than one (meth)acrylate group, and a photoinitiator.

Embodiment 225 of the invention is the polymerizable composition according to any one of Embodiments 101-224, the polymer forming part comprises one or more components comprising more than one (meth)acrylate group and a photoinitiator.

Embodiment 226 of the invention is the polymerizable composition according to any one of Embodiments 101-225, wherein the swellable particles comprise a polymer selected from polyesters, polyamides, polysiloxanes, polycarbonates, polyurethanes, vinyl polymers, polyacrylates, polymethacrylates, polyolefins, polybutadiene, styrene-butadiene rubber (SBR), nitrile butadiene rubber (NBR), or a combination thereof.

Embodiment 227 of the invention is the polymerizable composition according to any one of Embodiments 101-226, wherein the swellable particles comprise polybutadiene, polyisoprene, styrene/butadiene random copolymer, styrene/isoprene random copolymer, acrylic rubbers (e.g. polybutylacrylate), poly(hexamethylene carbonate), polysiloxane, ethylene/acrylate random copolymers and acrylic block copolymers, styrene/butadiene/(meth)acrylate (SBM) block-copolymers, styrene/butadiene block copolymer (styrene-butadiene-styrene block copolymer (SBS), styrene-isoprene-styrene block copolymer (SIS), their hydrogenated versions such as SEBS and SEPS, and ionomers, such as a copolymer of ethylene and acrylic acid cross-linked with a metal ion, such as of Mg or Zn.

Embodiment 228 of the invention is the polymerizable composition according to any one of Embodiments 101-227, wherein the swellable particles are formed by polymerizing a particle composition via free-radical polymerization, cationic polymerization, anionic polymerization, reduction oxidation, addition polymerization, or polycondensation, in the presence of appropriate solvents and surfactants.

Embodiment 229 of the invention is the polymerizable composition according to any one of Embodiments 101-228, wherein the swellable particles are formed from a particle composition as an emulsion with a dispersing medium comprising 50 wt % or more of water, based on the total weight of the particle composition, and dispersing medium.

Embodiment 230 of the invention is the polymerizable composition according to any one of Embodiments 101-229, wherein the swellable particles comprise a (meth)acrylate polymer.

Embodiment 231 of the invention is the polymerizable composition according to any one of Embodiments 101-230, wherein the swellable particles are formed from a particle composition comprising one or more components comprising one (meth)acrylate group, one or more components comprising more than one (meth)acrylate group, and a photoinitiator.

Embodiment 232 of the invention is the polymerizable composition according to any one of Embodiments 101-231, wherein the swellable particles are formed from a particle composition comprising one or more components comprising one or more components comprising more than one (meth)acrylate group and a photoinitiator.

Embodiment 233 of the invention is the polymerizable composition according to any one of Embodiments 101-232, wherein the swellable particles are present in an amount of from 3 to 40 wt %, based on the total amount of the swellable particles and the polymer forming part in the polymerizable composition, preferably from 5 to 40 wt %, more preferably from 8 to 40 wt %, more preferably from 8 to 35 wt %, more preferably from 8 to 30 wt %, more preferably from 3 to 25 wt %, more preferably from 5 to 25 wt %, more preferably from 8 to 25 wt %.

Embodiment 234 of the invention is the polymerizable composition according to any one of Embodiments 101-233, wherein the swellable particles comprise a surface functionality that comprises a polymerizable group.

Embodiment 235 of the invention is the polymerizable composition according to any one of Embodiments 101-234, wherein the swellable particles comprise a surface functionality that comprises a polymerizable group that is polymerizable by free-radical polymerization, cationic polymerization, anionic polymerization, reduction oxidation, addition polymerization, polycondensation.

Embodiment 236 of the invention is the polymerizable composition according to any one of Embodiments 101-235, wherein the swellable particles comprise a surface functionality that comprises a polymerizable group that comprises hydroxy, amino, sulpho, keto, ester, amide, acid, anhydride, acetoxy, or acetal.

Embodiment 237 of the invention is the polymerizable composition according to any one of Embodiments 101-236, wherein the swellable particles comprise a surface functionality selected from the group consisting of hydroxy, amino, epoxy, oxetane, (meth)acrylate, (meth)acrylamide, carboxyl, and vinylether, preferably (meth)acrylate.

Embodiment 238 of the invention is the polymerizable composition according to any one of Embodiments 101-237, wherein the polymer forming part comprises one or more components comprising one polymerizable group, one or more components comprising two or more polymerizable groups, and a photoinitiator.

Embodiment 239 of the invention is the polymerizable composition according to any one of Embodiments 101-238, wherein the swellable particles are formed from a particle composition comprising one or more components comprising one polymerizable group, one or more components comprising two or more polymerizable groups, and a photoinitiator.

Embodiment 240 of the invention is the polymerizable composition according to any one of Embodiments 101-239, wherein the polymer forming part comprises one or more components comprising two or more polymerizable groups and a photoinitiator.

Embodiment 241 of the invention is the polymerizable composition according to any one of Embodiments 101-240, wherein the swellable particles are formed from a particle composition comprising one or more components comprising two or more polymerizable groups and a photoinitiator.

Embodiment 242 of the invention is the polymerizable composition according to any one of Embodiments 101-241, wherein the polymer forming part comprises at least one polymerizable (meth)acrylate group in an amount of from 30 to 99.99 wt %, preferably from 40 to 99.9 wt %, more preferably from 45 wt % to 99.5 wt %, based on the total weight of the polymer forming part.

Embodiment 243 of the invention is the polymerizable composition according to any one of Embodiments 101-242, wherein the swellable particles are formed from a particle composition comprising at least one polymerizable (meth)acrylate group in an amount of from 30 to 99.99 wt %, preferably from 40 to 99.9 wt %, more preferably from 45 wt % to 99.5 wt %, based on the total weight of the particle composition.

Embodiment 244 of the invention is the polymerizable composition according to any one of Embodiments 101-243, wherein the polymer forming part comprises at least one free-radical photoinitiator in an amount of from 0.001 wt % to 8 wt %, preferably from 0.01 wt % to 5 wt %, more preferably from 0.05 wt % to 5 wt %, based on the total weight of the polymer forming part.

Embodiment 245 of the invention is the polymerizable composition according to any one of Embodiments 101-244, wherein the swellable particles are formed from a particle composition comprising at least one free-radical photoinitiator in an amount of from 0.001 wt % to 8 wt %, preferably from 0.01 wt % to 5 wt %, more preferably from 0.05 wt % to 5 wt %, based on the total weight of the particle composition.

Embodiment 246 of the invention is the polymerizable composition according to any one of Embodiments 101-245, wherein the polymer forming part comprises at least one cationically polymerizable component in an amount of 30 to 99.99 wt %, preferably from 40 to 99.9 wt %, more preferably from 45 wt % to 99.5 wt %, based on the total weight of the polymer forming part.

Embodiment 247 of the invention is the polymerizable composition according to any one of Embodiments 101-246, wherein the swellable particles are formed from a particle composition comprising at least one cationically polymerizable component in an amount of from 30 to 99.99 wt %, preferably from 40 to 99.9 wt %, more preferably from 45 wt % to 99.5 wt %, based on the total weight of the particle composition.

Embodiment 248 of the invention is the polymerizable composition according to any one of Embodiments 101-247, wherein the polymer forming part comprises at least one cationic photoinitiator in an amount of from 0.001 wt % to 8 wt %, preferably from 0.01 wt % to 5 wt %, more preferably from 0.05 wt % to 5 wt %, based on the total weight of the polymer forming part.

Embodiment 249 of the invention is the polymerizable composition according to any one of Embodiments 101-248, wherein the swellable particles are formed from a particle composition comprising at least cationic photoinitiator in an amount of from 0.001 wt % to 8 wt %, preferably from 0.01 wt % to 5 wt %, more preferably from 0.05 wt % to 5 wt %, based on the total weight of the particle composition.

Embodiment 250 of the invention is the polymerizable composition according to any one of Embodiments 101-249, wherein the polymerizable composition is substantially devoid of solvent.

Embodiment 251 of the invention is the polymerizable composition according to any one of Embodiments 101-250, wherein the polymerizable composition is devoid of solvent.

Embodiment 252 of the invention is the polymerizable composition according to any one of Embodiments 101-253 wherein the polymerizable composition is substantially devoid of aqueous solvent.

Embodiment 253 of the invention is the polymerizable composition according to any one of Embodiments 101-254, wherein the polymerizable composition is devoid of aqueous solvent.

Embodiment 254 of the invention is the polymerizable composition according to any one of Embodiments 101-253, wherein a filler is present at an amount of from 0.01 wt % to 25 wt %, preferably 0.01 wt % to 20 wt %, more preferably from 0.1 wt % to 15 wt %, more preferably from 1 wt % to 10 wt %, based on the total dry weight (excluding solvents) of the polymerizable composition.

Embodiment 255 of the invention is the polymerizable composition according to any one of Embodiments 101-254, wherein the filler is present and comprises an inorganic filler.

Embodiment 256 of the invention is the polymerizable composition according to any one of Embodiments 101-255, wherein the filler is present and comprises an organic filler.

Embodiment 257 of the invention is the polymerizable composition according to any one of Embodiments 101-256, wherein an initiator is present in the polymer forming part, preferably a photoinitiator or thermal initiator.

Embodiment 258 of the invention is the polymerizable composition according to any one of Embodiments 101-257, wherein an initiator is present in the polymer forming part, and the initiator is a free-radical photoinitiator or a cationic photoinitiator, preferably a free-radical photoinitiator.

Embodiment 259 of the invention is the polymerizable composition according to any one of Embodiments 101-258, wherein an initiator is present in the polymer forming part, and the initiator is a thermal photoinitiator, preferably selected from the group consisting of peroxides, azo compounds, and persulfates.

Embodiment 260 of the invention is the polymerizable composition according to any one of Embodiments 101-259, wherein the swellable particles are formed from a particle composition comprising at least one thermal initiator in an amount of from 0.001 wt % to 8 wt %, preferably from 0.01 wt % to 5 wt %, more preferably from 0.05 wt % to 5 wt %, based on the total weight of the particle composition.

Embodiment 261 of the invention is the polymerizable composition according to any one of Embodiments 101-249 or 254-260, wherein the polymerizable composition comprises a solvent, preferably a non-aqueous solvent.

Embodiment 262 of the invention is the polymerizable composition according to any one of Embodiments 101-249 or 254-261, wherein the one or more compounds comprising a polymerizable group in the polymer forming part comprises at least 50 wt %, preferably at least 60 wt %, more preferably at least 70 wt %, more preferably at least 80 wt %, more preferably at least 90 wt %, more preferably at least 95 wt %, based on the total weight of the compounds comprising a polymerizable group in the polymer forming part, of compounds that have a molar mass of 700 g/mol or less, preferably 650 g/mol or less, more preferably 600 g/mol or less, more preferably 550 g/mol or less, more preferably 500 g/mol or less, more preferably 450 g/mol or less, more preferably 400 g/mol or less, more preferably 350 g/mol or less, more preferably 300 g/mol or less.

Embodiment 263 of the invention is the polymerizable composition according to any one of Embodiments 101-249 or 254-262, wherein the one or more compounds comprising a polymerizable group in the polymer forming part comprises at least 50 wt %, preferably at least 60 wt %, more preferably at least 70 wt %, more preferably at least 80 wt %, more preferably at least 90 wt %, more preferably at least 95 wt %, based on the total weight of the compounds comprising a polymerizable group in the polymer forming part, of compounds that have a molar mass of from 70 to 700 g/mol, preferably from 70 to 650 g/mol, more preferably from 70 to 600 g/mol, more preferably from 70 to 550 g/mol, more preferably from 70 to 500 g/mol, more preferably from 70 to 450 g/mol, more preferably from 70 to 400 g/mol, more preferably from 70 to 350 g/mol, more preferably from 70 to 300 g/mol.

Embodiment 264 of the invention is the polymerizable composition according to any one of Embodiments 101-249 or 254-263, wherein the polymerizable composition comprises 50 wt % or less of solvent, based on the total weight of the polymerizable composition, preferably 40 wt % or less, more preferably 30 wt % or less, more preferably 20 wt % or less, more preferably 10 wt % or less, more preferably 5 wt % or less.

Embodiment 265 is the polymerizable composition according to any one of embodiments 101-264, wherein the combined amount of the polymer forming part and swellable particles in the polymerizable composition is at least 20 wt %, at least 30 wt %, at least 40 wt %, at least 50 wt %, at least 60 wt %, at least 70 wt %, at least 80 wt %, at least 90 wt %, or 100 wt % of the total polymerizable composition.

Embodiment 266 is the polymerizable composition according to any one of embodiments 101-265, wherein combined amount of the polymer forming part and swellable particles in the polymerizable composition is at most 98 wt %, at most 95 wt %, at most 90 wt %, at most 80 wt %, at most 70 wt %, or at most 60 wt % of the total polymerizable composition.

Embodiment 267 of the invention is a method of forming the polymerizable composition according to any one of Embodiments 101-266, comprising the steps of:
a. providing the swellable particles dispersed in a dispersing medium, and
b. forming the polymerizable composition by emulsifying the polymer forming part in the dispersing medium.

Embodiment 301 of the invention is a method of forming an article or coating, comprising the steps of:
a. Introducing into a mold or coating on a surface the polymerizable composition according to any one of Embodiments 101-264,
b. polymerizing the polymerizable composition, thereby forming the article or coating.

Embodiment 302 of the invention is the method according to Embodiment 301, further comprising the steps of swelling the article or coating with a second polymerizable composition and polymerizing the second polymerizable composition.

Embodiment 303 of the invention is the method according to Embodiment 302, wherein the second polymerizable composition swells the formed article or coating by 50% or more by mass of the formed article or coating, preferably 100% or more by mass, preferably 150% or more by mass, preferably 200% or more by mass, preferably 250% or more by mass, preferably 300% or more by mass, more preferably 400% or more by mass.

Embodiment 304 of the invention is a method of forming a three-dimensional object comprising the steps of forming a layer of the polymerizable composition according to any one Embodiments 101-264, curing the layer with actinic radiation to form a desired shape, and repeating the steps of forming and curing a layer of the polymerizable composition according to any one of Embodiments 101-264 a plurality of times to obtain a three-dimensional object.

Embodiment 350 of the invention is an article formed from the polymerizable composition or method of any of embodiments 101 to 304, wherein the article has a G₀ of 500 J/m² or more, a tensile modulus of 100 MPa or less, preferably 50 MPa or less, 30 MPa or less, 20 MPa or less, 15 MPa or less, 10 MPa or less, 7 MPa or less, or 5 MPa or less and a stress at break greater than its tensile modulus.

Embodiment 351 of the invention is the article according to Embodiment 350, wherein the tensile modulus is 0.1 MPa or more, or 0.2 MPa or more.

Embodiment 401 of the invention is an article comprising a multi-polymer network wherein at least one of polymer networks comprise particles swollen to a swelling ratio of 300% or more by mass, wherein the article has a G₀ of 500 J/m² or more, a tensile modulus of 100 MPa or less, preferably 50 MPa or less, more preferably 30 MPa or less, 20 MPa or less, 15 MPa or less, 10 MPa or less, 7 MPa or less, or 5 MPa or less and a stress at break greater than its tensile modulus.

Embodiment 402 of the invention is the article according to Embodiment 401, wherein the tensile modulus is 0.1 MPa or more, or 0.2 MPa or more.

Embodiment 403 of the invention is an article comprising a multi-polymer network wherein at least one of polymer networks comprise particles swollen to a swelling ratio of 250% or more by mass, wherein the article has a G₀ of 500 J/m² or more, a tensile modulus of 100 MPa or less, preferably 50 MPa or less, more preferably 30 MPa or less, 20 MPa or less, 15 MPa or less, 10 MPa or less, 7 MPa or less, or 5 MPa or less and a stress at break greater than its tensile modulus.

Embodiment 404 of the invention is the article according to Embodiment 403, wherein the tensile modulus is 0.1 MPa or more, or 0.2 MPa or more.

Embodiment 406 of the invention is the article according to any one of Embodiments 401-405, wherein the articles is formed from a polymerizable composition according to any one of Embodiments 101-267.

Embodiment 501 is a polymerizable composition comprising
a. a polymer forming part comprising
   i. one or more compounds comprising a polymerizable group, and
   ii. optionally, an initiator,
      wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 0.2 mol/l or less,
b. multi-network particles in an amount of 3 to 40 wt %, based on the total amount of the multi-network particles and the polymer forming part in the polymerizable composition, the multi-network particles comprising cross-links and being formed from a process comprising the steps of:
   i. swelling a first polymer network having a volume average cross-link density (v) at 100° C. of from 0.01 to 10 mol/l, as measured by DMTA, in a second network composition, the second network composition comprising
      1. one or more compounds comprising a polymerizable group, and
      2. optionally, an initiator,
   wherein a composition consisting of the second network composition, if 90% or more of the polymerizable groups in the second network composition are polymerized, has a Tg as determined by DMTA of less than 25° C. and a volume average cross-link density at 100° C. as determined by DMTA of 0.2 mol/l or less, and
   ii. polymerizing the second network composition, thereby forming a multi-network polymer,
wherein the first polymer network swells to a swelling ratio of 50% or more by mass from its non-swollen state if the first polymer network is swollen to equilibrium in the second network composition.

Embodiment 502 is the polymerizable composition according to Embodiment 501, wherein the first polymer network has a volume average cross-link density (v) at 100° C. of from 0.01 to 10 mol/l, preferably from 0.025 to 10 mol/l, more preferably from 0.05 g/mol to 10 mol/l, more preferably from 0.1 to 10 mol/l, more preferably from 0.2 to 10 mol/l, more preferably from 0.275 to 10 mol/l, more preferably from 0.5 to 10 mol/l, more preferably from 0.75 to 10 mol/l, more preferably from 1.0 to 10 mol/l, as measured by DMTA.

Embodiment 503 is the polymerizable composition according to Embodiment 501 or 502, wherein the first polymer network has a volume average cross-link density (v) at 100° C. of from 0.01 to 7 mol/l, preferably from 0.025 to 7 mol/l, more preferably from 0.05 g/mol to 7 mol/l, more preferably from 0.1 to 7 mol/l, more preferably from 0.2 to 7 mol/l, more preferably from 0.275 to 7 mol/l, more preferably from 0.5 to 7 mol/l, more preferably from 0.75 to 7 mol/l, more preferably from 1.0 to 7 mol/l, as measured by DMTA.

Embodiment 504 is the polymerizable composition according to any one of Embodiments 501-503, wherein the first polymer network has a volume average cross-link density (v) at 100° C. of from 0.01 to 5.5 mol/l, preferably from 0.025 to 5.5 mol/l, more preferably from 0.05 g/mol to 5.5 mol/l, more preferably from 0.1 to 5.5 mol/l, more preferably from 0.2 to 5.5 mol/l, more preferably from 0.275 to 5.5 mol/l, more preferably from 0.5 to 5.5 mol/l, more preferably from 0.75 to 5.5 mol/l, more preferably from 1.0 to 5.5 mol/l, as measured by DMTA.

Embodiment 505 is the polymerizable composition according to any one of Embodiments 501-504, wherein the first polymer network swells to a swelling ratio of 50%, preferably 100% or more, preferably 150% or more, preferably 200% or more, preferably 250% or more, preferably 300% or more, preferably 325% or more, more preferably 350% or more, more preferably 375% or more, more preferably 400% or more, or more preferably 425% or more by mass from its non-swollen state if the first polymer network is swollen to equilibrium in the second network composition.

Embodiment 506 is the polymerizable composition according to any one of Embodiments 501-505, wherein the first polymer network swells to a swelling ratio of from 50% to 5000%, preferably from 100% to 5000%, preferably from 150% to 5000%, preferably from 200% to 5000%, preferably from 250% to 5000%, preferably from 300% to 5000%, more preferably from 325% to 5000%, more preferably from 350% to 5000%, more preferably from 375% to 5000%, more preferably from 400% to 5000%, more preferably from 425% to 5000% by mass from its non-swollen state if the first polymer network is swollen to equilibrium in the second network composition.

Embodiment 507 is the polymerizable composition according to any one of Embodiments 501-506, wherein the multi-network particles swell to a swelling ratio of from 50% to 5000%, preferably from 100% to 2500%, preferably from 150% to 2500%, preferably from 200% to 2500%, preferably from 250% to 2500%, preferably 300% to 2500%, preferably from 325% to 2500%, more preferably from 350% to 2500%, more preferably from 375% to 2500%, more preferably from 400% to 2500%, more preferably from 425% to 2500% by mass from their non-swollen state if the multi-network particles are swollen to equilibrium in the polymer forming part.

Embodiment 508 is the polymerizable composition according to any one of Embodiments 501-507, wherein the multi-network particles swell to a swelling ratio of from 50% to 1500%, preferably from 100% to 1500%, preferably from 150% to 1500%, preferably from 200% to 1500%, preferably from 250% to 1500%, preferably 300% to 1500%, preferably from 325% to 1500%, more preferably from 350% to 1500%, more preferably from 375% to 1500%, more preferably from 400% to 1500%, more preferably from 425% to 1500% by mass from their non-swollen state if the multi-network particles are swollen to equilibrium in the polymer forming part.

Embodiment 509 is the polymerizable composition according to any one of Embodiments 501-508, wherein the multi-network particles comprising cross-links are formed from a process further comprising the step of milling or grinding the multi-network polymer, thereby forming multi-network particles.

Embodiment 510 is the polymerizable composition according to any one of Embodiments 501-509, wherein the first polymer network is present as particles.

Embodiment 511 of the invention is the polymerizable composition according to any one of Embodiments 501-510, wherein the one or more compounds comprising a polymerizable group in the polymer forming part of the second network composition comprise a compound that is polymerizable by free-radical polymerization, cationic polymerization, anionic polymerization, reduction oxidation, addition polymerization, or polycondensation.

Embodiment 512 of the invention is the polymerizable composition according to any one of Embodiments 501-511, wherein the one or more compounds comprising a polymerizable group in the polymer forming part or the second network composition comprise a polymerizable group selected from the group consisting of hydroxy, amino, sulpho, keto, ester, amide, acid, anhydride, acetoxy, and acetal.

Embodiment 513 of the invention is the polymerizable composition according to any one of Embodiments 501-512, wherein the one or more compounds comprising a polymerizable group in the polymer forming part or the second network composition comprise a polymerizable group the polymerizable group is selected from the group consisting of hydroxy, amino, epoxy, oxetane, (meth)acrylate, (meth)acrylamide, carboxyl, isocyanate, and vinylether, preferably (meth)acrylate.

Embodiment 514 of the invention is the polymerizable composition according to any one of Embodiments 501-513, wherein more than one different type of polymerizable group is present in the polymer forming part or the second network composition.

Embodiment 515 of the invention is the polymerizable composition according to any one of Embodiments 501-513, the polymer forming part or the second network composition comprises one or more components comprising one (meth)acrylate group, one or more components comprising more than one (meth)acrylate group, and a photoinitiator.

Embodiment 516 of the invention is the polymerizable composition according to any one of Embodiments 501-515, the polymer forming part or the second network composition comprises one or more components comprising more than one (meth)acrylate group and a photoinitiator.

Embodiment 517 of the invention is the polymerizable composition according to any one of Embodiments 501-516, wherein polymerizing the second network composition is done via free-radical polymerization, cationic polymerization, anionic polymerization, reduction oxidation, addition polymerization, or polycondensation.

Embodiment 518 of the invention is the polymerizable composition according to any one of Embodiments 501-517, wherein the first polymer network and/or the multi-network particles comprise a (meth)acrylate polymer.

Embodiment 519 of the invention is the polymerizable composition according to any one of Embodiments 501-518, wherein the first polymer network is formed from a particle composition comprising one or more components comprising one (meth)acrylate group, one or more components comprising more than one (meth)acrylate group, and a photoinitiator, or wherein the second network composition comprises one or more components comprising one (meth)acrylate group, one or more components comprising more than one (meth)acrylate group, and a photoinitiator.

Embodiment 520 of the invention is the polymerizable composition according to any one of Embodiments 501-519, wherein the first polymer network is formed from a particle composition comprising one or more components comprising one or more components comprising more than one (meth)acrylate group and a photoinitiator, or wherein the second network composition comprises one or more components comprising one or more components comprising one or more components comprising more than one (meth)acrylate group and a photoinitiator.

Embodiment 521 of the invention is the polymerizable composition according to any one of Embodiments 501-520, wherein the multi-network particles are present in an amount of from 3 to 40 wt %, based on the total amount of the swellable particles and the polymer forming part in the polymerizable composition, from 5 to 40 wt %, from 8 to 40 wt %, from 8 to 35 wt %, from 8 to 30 wt %, from 3 to 25 wt %, from 5 to 25 wt %, or from 8 to 25 wt %.

Embodiment 522 of the invention is the polymerizable composition according to any one of Embodiments 501-521, wherein the multi-network particles comprise a surface functionality that comprises a polymerizable group.

Embodiment 523 of the invention is the polymerizable composition according to any one of Embodiments 501-522, wherein the multi-network particles comprise a surface functionality that comprises a polymerizable group that is polymerizable by free-radical polymerization, cationic polymerization, anionic polymerization, reduction oxidation, addition polymerization, polycondensation.

Embodiment 524 of the invention is the polymerizable composition according to any one of Embodiments 501-523, wherein the multi-network particles comprise a surface functionality that comprises a polymerizable group that comprises hydroxy, amino, sulpho, keto, ester, amide, acid, anhydride, acetoxy, or acetal.

Embodiment 525 of the invention is the polymerizable composition according to any one of Embodiments 501-524, wherein the multi-network particles comprise a surface functionality selected from the group consisting of hydroxy, amino, epoxy, oxetane, (meth)acrylate, (meth)acrylamide, carboxyl, and vinylether, preferably (meth)acrylate.

Embodiment 526 of the invention is the polymerizable composition according to any one of Embodiments 501-525, wherein the polymer forming part and/or second network composition comprises one or more components comprising one polymerizable group, one or more components comprising two or more polymerizable groups, and a photoinitiator.

Embodiment 527 of the invention is the polymerizable composition according to any one of Embodiments 501-526, wherein the polymer forming part or second network composition comprises one or more components comprising two or more polymerizable groups and a photoinitiator.

Embodiment 528 of the invention is the polymerizable composition according to any one of Embodiments 501-527, wherein the first polymer network is formed from a composition comprising one or more components comprising two or more polymerizable groups and a photoinitiator.

Embodiment 529 of the invention is the polymerizable composition according to any one of Embodiments 501-528, wherein the polymer forming part and/or second network composition comprises at least one polymerizable (meth)acrylate group in an amount of from 30 to 99.99 wt %, preferably from 40 to 99.9 wt %, more preferably from 45 wt % to 99.5 wt %, based on the total weight of the polymer forming part or second network composition.

Embodiment 530 of the invention is the polymerizable composition according to any one of Embodiments 501-529, wherein the first polymer network is formed from a composition comprising at least one polymerizable (meth)acrylate group in an amount of from 30 to 99.99 wt %, preferably from 40 to 99.9 wt %, more preferably from 45 wt % to 99.5 wt %, based on the total weight of the first polymer network.

Embodiment 531 of the invention is the polymerizable composition according to any one of Embodiments 501-530, wherein the polymer forming part or second network composition comprises at least one free-radical photoinitiator in an amount of from 0.001 wt % to 8 wt %, preferably from 0.01 wt % to 5 wt %, more preferably from 0.05 wt % to 5 wt %, based on the total weight of the polymer forming part or second network composition.

Embodiment 532 of the invention is the polymerizable composition according to any one of Embodiments 501-531, wherein the first polymer network is formed from a composition comprising at least one free-radical photoinitiator in an amount of from 0.001 wt % to 8 wt %, preferably from 0.01 wt % to 5 wt %, more preferably from 0.05 wt % to 5 wt %, based on the total weight of the first polymer network.

Embodiment 533 of the invention is the polymerizable composition according to any one of Embodiments 501-532, wherein the polymer forming part or second network composition comprises at least one cationically polymerizable component in an amount of 30 to 99.99 wt %, preferably from 40 to 99.9 wt %, more preferably from 45 wt % to 99.5 wt %, based on the total weight of the polymer forming part or the second network composition.

Embodiment 534 of the invention is the polymerizable composition according to any one of Embodiments 501-533, wherein the first polymer network is formed from a composition comprising at least one cationically polymerizable component in an amount of from 30 to 99.99 wt %, preferably from 40 to 99.9 wt %, more preferably from 45 wt % to 99.5 wt %, based on the total weight of the first polymer network.

Embodiment 535 of the invention is the polymerizable composition according to any one of Embodiments 501-534, wherein the polymer forming part or second network composition comprises at least one cationic photoinitiator in an amount of from 0.001 wt % to 8 wt %, preferably from 0.01 wt % to 5 wt %, more preferably from 0.05 wt % to 5 wt %, based on the total weight of the polymer forming part or second network composition.

Embodiment 536 of the invention is the polymerizable composition according to any one of Embodiments 501-535, wherein the polymerizable composition is substantially devoid of solvent.

Embodiment 537 of the invention is the polymerizable composition according to any one of Embodiments 501-536, wherein the polymerizable composition is devoid of solvent.

Embodiment 538 of the invention is the polymerizable composition according to any one of Embodiments 501-537 wherein the polymerizable composition is substantially devoid of aqueous solvent.

Embodiment 539 of the invention is the polymerizable composition according to any one of Embodiments 501-538, wherein the polymerizable composition is devoid of aqueous solvent.

Embodiment 540 of the invention is the polymerizable composition according to any one of Embodiments 501-539, wherein a filler is present at an amount of from 0.01 wt % to 25 wt %, preferably 0.01 wt % to 20 wt %, more preferably from 0.1 wt % to 15 wt %, more preferably from 1 wt % to 10 wt %, based on the total dry weight (excluding solvents) of the polymerizable composition.

Embodiment 541 of the invention is the polymerizable composition according to any one of Embodiments 501-540, wherein the filler is present and comprises an inorganic filler.

Embodiment 542 of the invention is the polymerizable composition according to any one of Embodiments 501-541, wherein the filler is present and comprises an organic filler.

Embodiment 543 of the invention is the polymerizable composition according to any one of Embodiments 501-542, wherein an initiator is present in the polymer forming part, preferably a photoinitiator or thermal initiator.

Embodiment 544 of the invention is the polymerizable composition according to any one of Embodiments 501-543, wherein an initiator is present in the polymer forming part, and the initiator is a free-radical photoinitiator or a cationic photoinitiator, preferably a free-radical photoinitiator.

Embodiment 545 of the invention is the polymerizable composition according to any one of Embodiments 501-544, wherein an initiator is present in the polymer forming part, and the initiator is a thermal photoinitiator, preferably selected from the group consisting of peroxides, azo compounds, and persulfates.

Embodiment 546 of the invention is the polymerizable composition according to any one of Embodiments 501-545, wherein the one or more compounds comprising a polymerizable group in the polymer forming part comprises at least 50 wt %, preferably at least 60 wt %, more preferably at least 70 wt %, more preferably at least 80 wt %, more preferably at least 90 wt %, more preferably at least 95 wt %, based on the total weight of the compounds comprising a polymerizable group in the polymer forming part, of compounds that have a molar mass of 700 g/mol or less, preferably 650 g/mol or less, more preferably 600 g/mol or less, more preferably 550 g/mol or less, more preferably 500 g/mol or less, more preferably 450 g/mol or less, more preferably 400 g/mol or less, more preferably 350 g/mol or less, more preferably 300 g/mol or less.

Embodiment 547 of the invention is the polymerizable composition according to any one of Embodiments 501-546, wherein the one or more compounds comprising a polymerizable group in the polymer forming part comprises at least 50 wt %, preferably at least 60 wt %, more preferably at least 70 wt %, more preferably at least 80 wt %, more preferably at least 90 wt %, more preferably at least 95 wt %, based on the total weight of the compounds comprising a polymerizable group in the polymer forming part, of compounds that have a molar mass of from 70 to 700 g/mol, preferably from 70 to 650 g/mol, more preferably from 70 to 600 g/mol, more preferably from 70 to 550 g/mol, more preferably from 70 to 500 g/mol, more preferably from 70 to 450 g/mol, more preferably from 70 to 400 g/mol, more preferably from 70 to 350 g/mol, more preferably from 70 to 300 g/mol.

Embodiment 548 of the invention is the polymerizable composition according to any one of Embodiments 501-547, wherein the polymerizable composition comprises 50 wt % or less of solvent, based on the total weight of the polymerizable composition, preferably 40 wt % or less, more preferably 30 wt % or less, more preferably 20 wt % or less, more preferably 10 wt % or less, more preferably 5 wt % or less.

Embodiment 549 is the polymerizable composition according to any one of embodiments 501-548, wherein the combined amount of the polymer forming part and multi-network particles in the polymerizable composition is at least 20 wt %, at least 30 wt %, at least 40 wt %, at least 50 wt %, at least 60 wt %, at least 70 wt %, at least 80 wt %, at least 90 wt %, or 100 wt % of the total polymerizable composition.

Embodiment 550 is the polymerizable composition according to any one of embodiments 501-549, wherein combined amount of the polymer forming part and multi-network particles in the polymerizable composition is at most 98 wt %, at most 95 wt %, at most 90 wt %, at most 80 wt %, at most 70 wt %, or at most 60 wt % of the total polymerizable composition.

Embodiment 551 of the invention is a method of forming the polymerizable composition according to any one of Embodiments 501-550, comprising the steps of:
a. providing the multi-network particles dispersed in a dispersing medium, and
b. forming the polymerizable composition by emulsifying the polymer forming part in the dispersing medium.

Embodiment 552 of the invention is a method of forming an article or coating, comprising the steps of:
a. Introducing into a mold or coating on a surface the polymerizable composition according to any one of Embodiments 501-550,
b. polymerizing the polymerizable composition, thereby forming the article or coating.

Embodiment 553 of the invention is the method according to Embodiment 552, further comprising the steps of swelling the article or coating with a second polymerizable composition and polymerizing the second polymerizable composition.

Embodiment 554 of the invention is the method according to Embodiment 553, wherein the second polymerizable composition swells the formed article or coating by 50% or more by mass of the formed article or coating, preferably 100% or more by mass, preferably 150% or more by mass, preferably 200% or more by mass, preferably 250% or more by mass, preferably 300% or more by mass, more preferably 400% or more by mass.

Embodiment 555 of the invention is a method of forming a three-dimensional object comprising the steps of forming a layer of the polymerizable composition according to any one Embodiments 501-550, curing the layer with actinic radiation to form a desired shape, and repeating the steps of forming and curing a layer of the polymerizable composition according to any one of Embodiments 501-550 a plurality of times to obtain a three-dimensional object.

Embodiment 556 of the invention is an article formed from the polymerizable composition or method of any of embodiments 501-555, wherein the article has a G₀ of 500 J/m² or more, a tensile modulus of 100 MPa or less, preferably 50 MPa or less, 30 MPa or less, 20 MPa or less, 15 MPa or less, 10 MPa or less, 7 MPa or less, or 5 MPa or less and a stress at break greater than its tensile modulus.

Embodiment 557 of the invention is the article according to Embodiment 556, wherein the tensile modulus is 0.1 MPa or more, or 0.2 MPa or more.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. While certain optional features are described as embodiments of the invention, the description is meant to encompass and specifically disclose all combinations of these embodiments unless specifically indicated otherwise or physically impossible.

1. A polymerizable composition comprising:
a. a polymer forming part comprising
i. one or more compounds comprising a polymerizable group, and
ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 0.2 mol/l or less,
b. swellable particles in an amount of 5 to 35 wt %, based on the total amount of the swellable particles and the polymer forming part in the polymerizable composition, the swellable particles comprising cross-links and having
i. a Tg of less than 25° C., as determined by DMTA by first drying the swellable particles in air until they form a film and then drying the film for 16 hours in a vacuum oven at 80° C.,
ii. a 1/T₂ of from 0.1 ms¹ to 10 ms⁻¹, where T₂ is the time at which the signal amplitude has decayed to 1/e of its original value as determined by solid state NMR T₂ relaxometry at 110° C. using a HEPS, and
wherein the swellable particles swell to a swelling ratio of 250% or more by mass from their non-swollen state if the swellable particles are swollen to equilibrium in a mixture consisting of the polymer forming part and the swellable particles,
a. optionally, a solvent, and
b. optionally, a filler.

2. The polymerizable composition according to claim 1, wherein the polymerizable composition contains less than 5 wt % of water, based on the total weight of the polymerizable composition.

3. The polymerizable composition according to claim 1, wherein the viscosity of the polymerizable composition is from 0.01 to 3000 Pa-s at 25° C. measured using a shear rate of 50 s¹.

4. The polymerizable composition according to claim 1, wherein the swellable particles have an unswollen particle diameter of from 10 nm to 10 μm when measured by photon correlation spectroscopy in water.

5. The polymerizable composition according to claim 1, wherein the swellable particles have a 1/T₂ of from 0.3 ms¹ to 5 ms⁻¹, where T₂ is the time at which the signal amplitude has decayed to 1/e of its original value as determined by solid state NMR T₂ relaxometry at 110° C. using a HEPS.

6. The polymerizable composition according to claim 1, wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of from 0.005 mol/l to 0.15 mol/l.

7. The polymerizable composition according to claim 1, wherein the swellable particles swell to a swelling ratio of from 300% to 1500% by mass from their non-swollen state if the swellable particles are swollen to equilibrium in a mixture consisting of the polymer forming part and the swellable particles.

8. The polymerizable composition according to claim 1, wherein the polymerizable composition is substantially devoid of solvent.

9. The polymerizable composition according to claim 1, wherein the polymer forming part comprises
a. a component comprising one (meth)acrylate group,
b. a component comprising more than one (meth)acrylate group, and
c. a free-radical polymerization initiator.

10. The polymerizable composition according to claim 1, wherein the swellable particles comprise an acrylate polymer.

11. The polymerizable composition according to claim 1, wherein the polymer forming part comprises a cationically polymerizable component and a cationic photoinitiator.

12. A method of forming an article or coating, comprising the steps of:
a. introducing into a mold or coating on a surface the polymerizable composition according to claim 1, and
b. polymerizing the polymerizable composition, thereby forming the article or coating.

13. The method according to claim 12, further comprising the steps of swelling the article or coating with a second polymerizable composition and polymerizing the second polymerizable composition.

14. A method of forming a three-dimensional object comprising the steps of forming a layer of the polymerizable composition according to claim 1, curing the layer with actinic radiation to form a desired shape, and repeating the steps of forming and curing a layer of the polymerizable composition a plurality of times to obtain a three-dimensional object.

15. An article comprising a multi-polymer network wherein at least one of polymer networks comprise particles swollen to a swelling ratio of 250% or more by mass, wherein the article has a G₀ of 500 J/m² or more as measured in accordance with ISO 34-2:2015, a tensile modulus of 30 MPa or less, and a stress at break greater than its tensile modulus, as measured in accordance with ISO 37 (3^{rd} Edition 1994-05-15).

16. The article according to claim 15, wherein the article is formed by polymerizing a polymerizable composition comprising:
a. a polymer forming part comprising
i. one or more compounds comprising a polymerizable group, and
ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 0.2 mol/l or less,
b. swellable particles in an amount of 5 to 35 wt %, based on the total amount of the swellable particles and the polymer forming part in the polymerizable composition, the swellable particles comprising cross-links and having
i. a Tg of less than 25° C., as determined by DMTA by first drying the swellable particles in air until they form a film and then drying the film for 16 hours in a vacuum oven at 80° C.,
ii. a 1/T₂ of from 0.1 ms¹ to 10 ms⁻¹, where T₂ is the time at which the signal amplitude has decayed to 1/e of its original value as determined by solid state NMR T₂ relaxometry at 110° C. using a HEPS, and
wherein the swellable particles swell to a swelling ratio of 250% or more by mass from their non-swollen state if the swellable particles are swollen to equilibrium in a mixture consisting of the polymer forming part and the swellable particles,
c. optionally, a solvent, and
d. optionally, a filler.

17. A polymerizable composition comprising:
a. a polymer forming part comprising
i. one or more compounds comprising a polymerizable group, and
ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 1.0 mol/l or less,
b. swellable particles in an amount of 5 to 35 wt %, based on the total amount of the swellable particles and the polymer forming part in the polymerizable composition, the swellable particles comprising cross-links, being formed from a particle composition, and having
i. a Tg of less than 25° C., as determined by DMTA by first drying the swellable particles in air until they form a film and then drying the film for 16 hours in a vacuum oven at 80° C.,
ii. a volume average cross-link density (v) at 100° C. of 0.01 mol/l or more, as measured by DMTA on a film formed by curing the particle composition, such that 90% or more of the polymerizable groups in the particle composition are polymerized, and
wherein the swellable particles swell to a swelling ratio of 250% or more by mass from their non-swollen state if the swellable particles are swollen to equilibrium in a mixture consisting of the polymer forming part and the swellable particles,
c. optionally, a solvent, and
d. optionally, a filler.

18. A method of forming the polymerizable composition of claim 1, comprising the steps of:
a. providing the swellable particles dispersed in a dispersing medium, and
b. forming the polymerizable composition by emulsifying the polymer forming part in the dispersing medium.

19. A polymerizable composition comprising
a. a polymer forming part comprising
i. one or more compounds comprising a polymerizable group, and
ii. optionally, an initiator,
wherein a composition consisting of the polymer forming part, if 90% or more of the polymerizable groups in the polymer forming part are polymerized, has a Tg as determined by DMTA of less than 25° C. and a volume average cross-link density at 100° C. as determined by DMTA of 0.2 mol/l or less,
b. multi-network particles in an amount of from 3 to 40 wt %, based on the total amount of the multi-network particles and the polymer forming part in the polymerizable composition, the multi-network particles comprising cross-links and being formed from a process comprising the steps of:
i. swelling a first polymer network having a volume average cross-link density (v) at 100° C. of from 0.01 to 10 mol/l as measured by DMTA, in a second network composition comprising
1. one or more compounds comprising a polymerizable group, and
2. optionally, an initiator,
wherein a composition consisting of the second network composition, if 90% or more of the polymerizable groups in the second network composition are polymerized, has a Tg as determined by DMTA of less than 25° C. and a volume average cross-link density at 100° C. as determined by DMTA of 0.2 mol/l or less, and
ii. polymerizing the second network composition, thereby forming a multi-network polymer,
wherein the first polymer network swells to a swelling ratio of 50% or more by mass from its non-swollen state if the first polymer network is swollen to equilibrium in the second network composition.

20. The polymerizable composition according to claim 2, wherein the polymer forming part comprises
a. a component comprising one (meth)acrylate group,
b. a component comprising more than one (meth)acrylate group, and
c. a free-radical polymerization initiator,
wherein the swellable particles comprise an acrylate polymer,
and wherein the swellable particles swell to a swelling ratio of from 300% to 1500% by mass from their non-swollen state if the swellable particles are swollen to equilibrium in a mixture consisting of the polymer forming part and the swellable particles.
